(19) United States
(12) Patent Application Publication
(10) Pub. No.: US 2026/0049019 A1
(43) Pub. Date: Feb. 19, 2026

(54) HOLLOW-CORE OPTICAL FIBERS AND METHODS FOR PRODUCING THE SAME

(71) Applicant: CORNING INCORPORATED, Corning, NY (US)

(72) Inventors: Sushmit Sunil Kumar Goyal, Painted Post, NY (US); Shivam Sahu, Horseheads, NY (US); Pushkar Tandon, Painted Post, NY (US)

(21) Appl. No.: 19/283,341

(22) Filed: Jul. 29, 2025

Related U.S. Application Data
(60) Provisional application No. 63/683,461, filed on Aug. 15, 2024.

(51) Int. Cl. C03B 15/14; C03B 25/04

(52) U.S. Cl. CPC C03B 15/14; C03B 25/04; C03B 2203/16; C03B 2205/12; C03B 2205/60

(57) ABSTRACT

A method may include: feeding a hollow-core preform into a draw furnace at a preform feed rate Vₚ; heating the hollow-core preform comprising an outer tube having an inner radius/diameter rₚ/ID_{preform} and an outer radius/diameter Rₚ/OD_{preform}; and drawing a hollow-core optical fiber from the hollow-core preform at a fiber draw rate V_{f} and a draw tension τ, thereby elongating the outer tube of the hollow-core preform to an outer cladding of the hollow-core optical fiber having an inner radius/diameter r_{f}/ID_{fiber} and an outer radius/diameter R_{f}/OD_{fiber}; wherein: the interior cavity of the outer tube is under a differential core pressure P_{core}, the differential core pressure P_{core}, the inner and outer radii rₚ and Rₚ of the outer tube are selected such that a tight control over target inner and outer radii r_{f} and R_{f} and a fiber dimension sensitivity ΔID_{fiber} of the outer cladding can be achieved.

This application claims the benefit of priority under 35 U.S.C. § 119 of U.S. Provisional Application Ser. No. 63/683,461 filed on Aug. 15, 2024, the content of which is relied upon and incorporated herein by reference in its entirety.

### FIELD

The present disclosure generally relates to methods for producing optical fibers, and more specifically, to methods for producing hollow-core optical fibers.

### BACKGROUND

Hollow-core optical fibers are a new class of fibers that are attractive because of their optical properties of low loss, low attenuation, low latency, ultralow non-linearity, low flat dispersion, ultra broadband transmission, radiation hardness, and negligible Rayleigh backscattering. However, hollow-core optical fibers also suffer from the need for high precision of fiber microstructures. A typical design of an anti-resonant hollow core optical fiber may include an outer cladding along with two or more non-touching capillaries (or nested capillaries) attached on the inner surface of the outer cladding to define the hollow core through which the light is propagated. The light is propagated through the hollow core, and multiple low loss regions for light propagation can be identified. The propagation characteristics of the hollow-core optical fibers, such as anti-resonant optical fibers, are strongly related to the microstructures and dimensions thereof for effective guiding by the waveguide.

Hollow-core optical fibers can be produced by drawing a hollow-core preform into fiber. During the manufacture of the anti-resonant hollow-core optical fiber, especially when the starting preform sizes are increased for continuously drawing longer lengths of the fiber, the relative dimensions of the outer cladding and the capillaries may not be preserved from the preform to the fiber during the drawing of the fiber. Additionally, the fiber dimensions obtained may also deviate from target dimensions due to, e.g., the variation/instability in the processing conditions. Accordingly, it is important to understand the change in dimensions of the different components of the fiber during the draw process for scaling up and manufacturability.

### SUMMARY

Described herein are methods and processes addressing challenges in scaling up of the hollow-core optical fiber drawing process to large-volume manufacturing via the capped (or sealed) capillary method of manufacturing or the active pressure method. The inventors have recognized that the degree of change in microstructure from the preform to the fiber may be impacted by the size of the preform and/or the size of the draw hot zone. The inventors further recognize that the surface tension and/or pressure forces inside the outer cladding tube during the draw process may also affect the dimensions of the outer cladding and the capillaries of the fiber drawn. Accordingly, the inventors have developed methods and processes for achieving targe fiber microstructure dimensions with high precision, including but not limited to determining the process conditions for attaining desired microstructures in the hollow-core optical fiber from hollow-core preform of different sizes during scaleup, reducing variation in fiber microstructure dimensions during the drawing process for longer fiber lengths, which are all significant for scaleup and realizing low-cost large volume manufacturing of anti-resonant optical fibers. The various methods and processes described herein may maintain constant core diameter and mode field, maintain consistent confinement loss along the length of the drawn fiber, prevent mid-draw contact of capillaries, etc.

In some embodiments, a method of producing a hollow-core optical fiber from a hollow-core preform may include feeding a hollow-core preform into a draw furnace at a preform feed rate Vₚ in mm/min. The method may further include heating the hollow-core preform comprising an outer tube having an inner surface defining an interior cavity and an inner radius rₚ in mm of the outer tube of the hollow-core preform and an outer surface defining an outer radius Rₚ in mm of the outer tube of the hollow-core preform. The method may further include drawing a hollow-core optical fiber from the hollow-core preform at a fiber draw rate V_{f} in mm/min and a draw tension τ in grams, thereby elongating the outer tube of the hollow-core preform to an outer cladding of the hollow-core optical fiber. The outer cladding may include an inner surface defining an inner radius r_{f} in μm of the outer cladding of the hollow-core fiber and an outer surface defining an outer radius R_{f} in μm of the outer cladding of the hollow-core optical fiber. In some embodiments, the interior cavity of the outer tube of the hollow-core preform may be under a differential core pressure P_{core} in psig that satisfy the following relation: 0.8×P*<P_{core}<1.2×P*, where: P*=1.877×10⁻⁵×τ^{1.46}, the inner radius rₚ of the outer tube of the hollow-core preform and the outer radius Rₚ of the outer tube of the hollow-core preform satisfy the following relations:

$$0.9 \times {r}_{p}^{*} < {r}_{p} < 1.1 \times {r}_{p}^{*} , and 0.95 \times {R}_{p}^{*} < {R}_{p} < 1.05 \times {R}_{p}^{*} ,$$

and where:

$${r}_{p}^{*} = \frac{{r}_{f}}{{( {V}_{f} / {V}_{p} )}^{- ( T + 3 π {R}_{*} σ - 3 π {P}_{core} {R}_{*}^{2} ) / 2 T}} , and {R}_{p}^{*} = \frac{{R}_{f}}{{( {V}_{f} / {V}_{p} )}^{- ( T + 3 π {r}_{*} σ - 3 π {P}_{core} {r}_{*}^{2} ) / 2 T}} ,$$

and where: T is the draw tension in dynes, and T=981×τ, σ is a surface energy of a glass material forming the outer tube,

$${r}_{*} = 5 \sqrt{{r}_{p}^{*} {r}_{f}} , and {R}_{*} = 5 \sqrt{{R}_{p}^{*} {R}_{f}} .$$

In some embodiments, a method of producing a hollow-core optical fiber from a hollow-core preform may include feeding a hollow-core preform into a draw furnace at a preform feed rate Vₚ (in mm/min). The method may further include heating the hollow-core preform comprising an outer tube having an inner surface defining an interior cavity and an inner diameter ID_{preform} (in mm) of the outer tube of the hollow-core preform and an outer surface defining an outer diameter OD_{preform} (in mm) of the outer tube of the hollow-core preform. The method may further include drawing a hollow-core optical fiber from the hollow-core preform at a fiber draw rate V_{f} (in mm/min) and a draw tension τ, thereby elongating the outer tube of the hollow-core preform to an outer cladding of the hollow-core optical fiber having an inner surface defining an inner diameter ID_{fiber} (in μm) of the outer cladding of the hollow-core fiber and an outer surface defining an outer diameter OD_{fiber} (in μm) of the outer cladding of the hollow-core optical fiber. In some embodiments, a fiber dimension sensitivity ΔID_{fiber} (in μm), as defined as a variation in the inner diameter ID_{fiber} of the outer cladding of the hollow-core optical fiber when a differential core pressure P_{core} undergoes a fluctuation of 0.01 psig, satisfies the following: ΔID_{fiber}=M×Θ, where: M is a proportionality constant and M=2277.778×ID_{fiber}+(1.197×10⁵), Θ is a grouping parameter and

$$Θ = A \times {x}^{- 1.18} \times {T}_{fiber}^{- 2} ,$$

where A is a scaling factor and

$$A = \frac{O {D}_{preform}^{2} - I {D}_{preform}^{2}}{136} ,$$

x is the operating draw stress (in MPa) and

$$x = \frac{4}{π} \times \frac{τ}{( O {D}_{fiber}^{2} - I {D}_{fiber}^{2} )} ,$$

and T_{fiber} (in μm) is the thickness of the outer cladding of the hollow-core optical fiber and

$${T}_{fiber} = \frac{1}{2} O {D}_{fiber} - \frac{1}{2} I {D}_{fiber} .$$

In some embodiments, a method of producing a hollow-core optical fiber from a hollow-core preform may include feeding a hollow-core preform into a draw furnace at a preform feed rate Vₚ (in mm/min). The method may further include heating the hollow-core preform comprising an outer tube having an inner surface defining an interior cavity and an inner radius rₚ (in mm) and an inner diameter ID_{preform}=2×rₚ (in mm) of the outer tube of the hollow-core preform and an outer surface defining an outer radius Rₚ (in mm) and an outer diameter OD_{preform}=2×Rₚ (in mm) of the outer tube of the hollow-core preform. The method may further include drawing a hollow-core optical fiber from the hollow-core preform at a fiber draw rate V_{f} (in mm/min) and a draw tension τ (in gram), thereby elongating the outer tube of the hollow-core preform to an outer cladding of the hollow-core optical fiber, the outer cladding having an inner surface defining an inner radius r_{f} (in μm) and an inner diameter ID_{fiber}=2×r_{f} of the outer cladding of the hollow-core fiber and an outer surface defining an outer radius R_{f} (in μm) and an outer diameter OD_{fiber}=2×R_{f} of the outer cladding of the hollow-core optical fiber. In some embodiments, the interior cavity of the outer tube of the hollow-core preform is under a differential core pressure P_{core} in psig that may satisfy the following relation: 0.8×P*<P_{core}<1.2×P*, where: P*=1.877×10⁻⁵×τ^{1.46}, the inner radius rₚ of the outer tube of the hollow-core preform and the outer radius Rₚ of the outer tube of the hollow-core preform satisfy the following relations:

$$0.9 \times {r}_{p}^{*} < {r}_{p} < 1.1 \times {r}_{p}^{*} , and 0.95 \times {R}_{p}^{*} < {R}_{p} < 1.05 \times {R}_{p}^{*} ,$$

where:

$${r}_{p}^{*} = \frac{{r}_{f}}{{( {V}_{f} / {V}_{p} )}^{- ( T + 3 π {R}_{*} σ - 3 π {P}_{core} {R}_{*}^{2} ) / 2 T}} , {R}_{p}^{*} = \frac{{R}_{f}}{{( {V}_{f} / {V}_{p} )}^{- ( T + 3 π {r}_{*} σ - 3 π {P}_{core} {r}_{*}^{2} ) / 2 T}} ,$$

where T is the draw tension in dynes, and T=981×τ, σ is a surface energy of a glass material forming the outer tube of the hollow-core preform,

$${r}_{*} = 5 \sqrt{{r}_{p}^{*} {r}_{f}} , and {R}_{*} = 5 \sqrt{{R}_{p}^{*} {R}_{f}} .$$

In some embodiments, a fiber dimension sensitivity ΔID_{fiber} (in μm), as defined as a variation in the inner diameter ID_{fiber} of the outer cladding of the hollow-core optical fiber when the differential core pressure P_{core} undergoes a fluctuation of 0.01 psig, may satisfy the following: ΔID_{fiber}=M×Θ, where: M is a proportionality constant and M=2277.778×ID_{fiber}+(1.197×10⁵), Θ is a grouping parameter and

$$Θ = A \times {x}^{- 1.18} \times {T}_{fiber}^{- 2} ,$$

where A is a scaling factor and

$$A = \frac{O {D}_{preform}^{2} - I {D}_{preform}^{2}}{136} ,$$

x is the operating draw stress (in MPa) and

$$x = \frac{4}{π} \times \frac{τ}{( O {D}_{fiber}^{2} - I {D}_{fiber}^{2} )} ,$$

and T_{fiber} (in μm) is the thickness of the outer cladding of the hollow-core optical fiber and

$${T}_{fiber} = \frac{1}{2} O {D}_{fber} - \frac{1}{2} I {D}_{fiber} .$$

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying figured.

FIGS. 1A and 1B schematically depict cross-sectional views of exemplary hollow-core optical fibers.

FIGS. 2A and 2B schematically depict cross-sectional views of exemplary hollow-core preforms for drawing the hollow-core optical fibers of FIG. 1A and FIG. 1B, respectively.

FIG. 3 schematically depicts an exemplary drawing system.

FIG. 4 schematically illustrates an implementation of a finite-analytic solution of evolution of preform outer tube inner and outer radii.

FIGS. 5A and 5B show the evolution of perform outer and inner diameters as a function of axial draw velocity in the neckdown region with different draw parameters.

FIG. 6 is a plot of fiber dimension sensitivity as a function of preform outer tube outer diameter.

FIG. 7 is a plot of fiber dimension sensitivity multiplied by the square of fiber outer cladding thickness as a function of draw stress.

FIG. 8 is a plot of fiber dimension sensitivity as a function of a grouping parameter Θ.

FIG. 9 is a plot of draw tension needed for maintaining fiber dimension sensitivity as a function of fiber outer cladding outer diameter.

FIG. 10 is a plot of draw tension needed for maintaining fiber dimension sensitivity as a function of fiber yield.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “≤” are used interchangeably, “greater than” and “>” are used interchangeably, and “less than” and “<” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

Directional terms as used herein—for example up, down, right, left, front, back, top, bottom—are made only with reference to the figures as drawn and are not intended to imply absolute orientation.

Various components described herein may be referred to as “directly connected” or “indirectly connected.” Components are directly connected when they are joined to one another with no intervening structure. Components may be joined by fusing, melting, welding, soldering, adhesives, or any other suitable attachment means. Components are “indirectly connected” when they are joined to one another with intervening structure. Examples of intervening structure include welding aids (e.g. frits, solders, fluxes), adhesives, and bonding materials. In some embodiments, components connected indirectly are connected only by a welding aid, adhesive, or bonding material. The term “connected” means “directly connected” or “indirectly connected.” Components “directly connected” to one another are said to be in direct contact with each other. Components “indirectly connected” to one another are said to be in indirect contact with each other. Components “connected” to one another are in direct or indirect contact with each other.

As used herein, the terms “upstream” and “downstream” refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation.

As used herein, the term “linear” refers to relative distances/lengths between points. A “linear” distance/length may refer to a distance between two points along a straight line.

As used herein, the singular forms “a,” “an” and “the” include plural referents in addition to the single referent unless the context clearly dictates otherwise. Thus, for example, reference to “a” component includes aspects having one such component as well as two or more such components, unless the context clearly indicates otherwise.

Reference will now be made in detail to various embodiments. Whenever possible, the same reference numerals will be used throughout the drawings to refer to the same or like parts.

### Hollow-Core Optical Fiber

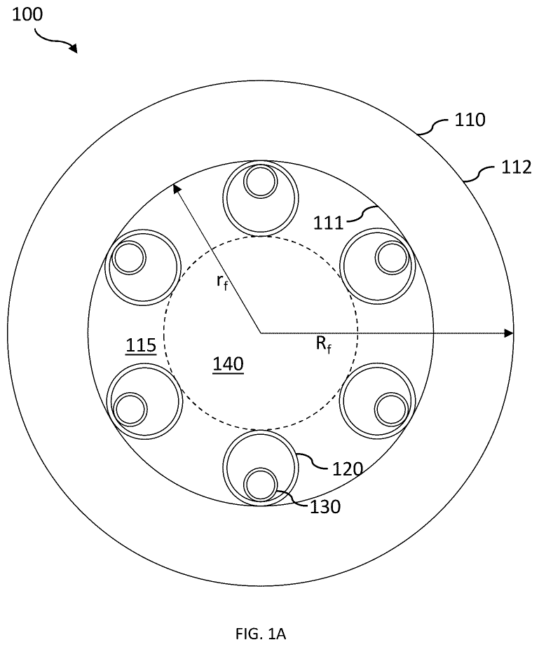

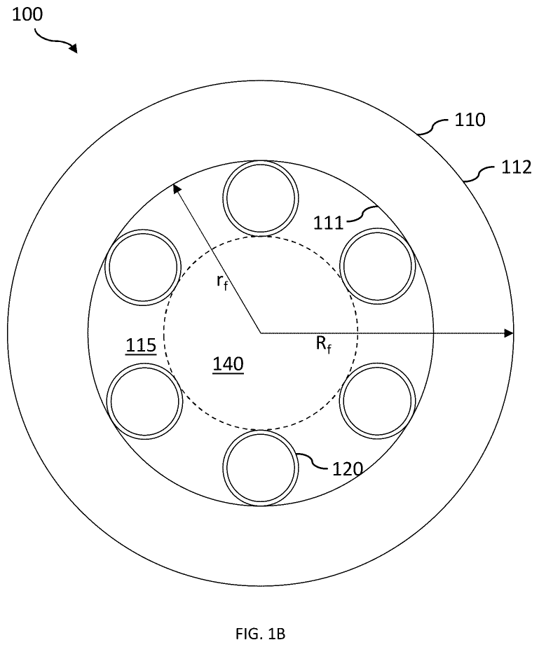

FIG. 1A schematically illustrates an example of a hollow-core optical fiber 100. The hollow-core optical fiber 100 may include an outer cladding 110. The outer cladding 110 may include an inner surface 111 defining an interior cavity 115 and an inner radius r_{f} of the outer cladding 110, and an outer surface 112 defining an outer radius R_{f} of the outer cladding 110. The hollow-core optical fiber 100 may further include two or more (e.g., two, three, four, five, six, or more) cladding elements, such as capillaries 120, inside the interior cavity 115 of the outer cladding 110. The capillaries 120 may be in contact with and/or attached to the inner surface 111 of the outer cladding 110. The capillaries 120 may not be in contact with each other and may be evenly spaced along the inner surface 111 of the outer cladding 110. In some embodiments, the cladding elements of the hollow-core optical fiber 100 may also include nested capillaries 130 with each disposed inside a capillary 120 and in contact with and/or attached to an inner surface of the capillary 120. In some embodiments, the hollow-core optical fiber 100 may not include nested capillaries 130, such as shown in FIG. 1B. The cladding elements of the hollow-core optical fiber 100, e.g., the capillaries 120 and/or the nested capillaries 130, may surround and define a hollow core 140 of the hollow-core optical fiber 100. The hollow core 140 may be the central portion of the interior cavity 115 and may correspond to the region of the hollow-core optical fiber 100 in which optical signals may be primarily confined and propagate. In some embodiments, the outer cladding 110, the capillaries 120, and/or the nested capillaries 130 may include silica glass and/or silica-based glass (i.e., silica glass comprising one or more dopants).

### Hollow-Core Preform

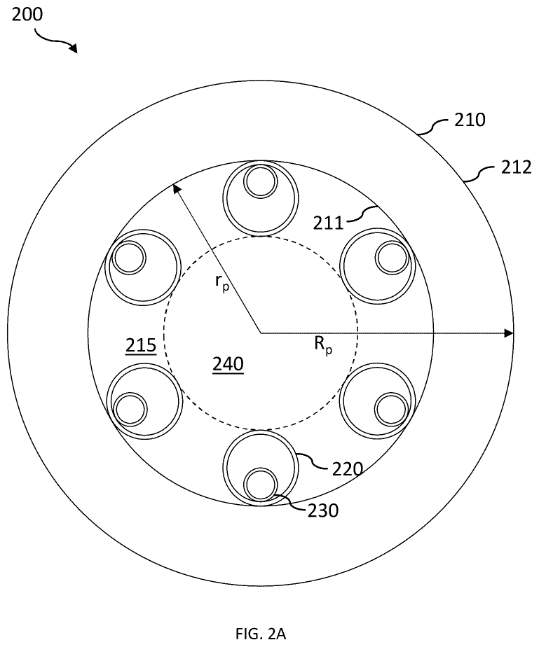

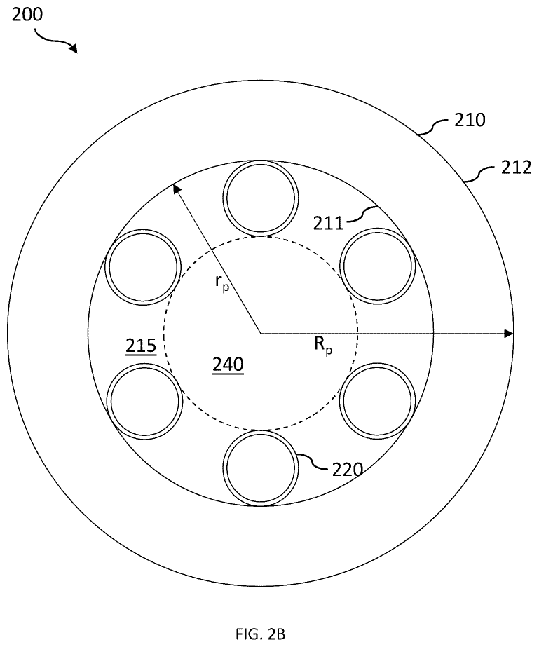

The hollow-core optical fiber 100 may be produced by drawing a hollow-core preform into fiber. FIGS. 2A and 2B schematically illustrate non-limiting examples of hollow-core preform 200 that may be utilized for producing the hollow-core optical fiber 100 shown in FIGS. 1A and 1B, respectively. In some embodiments, the hollow-core preform 200 may include an outer tube 210. The outer tube 210 may include an inner surface 211 defining an interior cavity 215 and an inner radius rₚ of the outer tube 210, and an outer surface 212 defining an outer radius Rₚ of the outer tube 210. In some embodiments, the hollow-core preform 200 may further include two or more (e.g., two, three, four, five, six, or more) inner tubes 220 inside the interior cavity 215 of the outer tube 210. In some embodiments, the inner tubes 220 may be in contact with and/or attached to the inner surface 211 of the outer tube 210. In some embodiments, the inner tubes 220 may not be in contact with each other and may be evenly spaced along the inner surface 211 of the outer tube 210. In some embodiments, such as shown in FIG. 2A, the hollow-core preform 200 may also include two or more nested tubes 230 with each disposed inside an inner tube 220 and in contact with and/or attached to an inner surface of the inner tube 220. In some embodiments, the hollow-core preform 200 may not include nested tubes 230, such as shown in FIG. 2B. The inner tubes 220 may surround and define a hollow section 240 that may be the central portion of the interior cavity 215 and correspond to the hollow core 140 of the hollow-core optical fiber 100 that may be drawn from the hollow-core preform 200. In some embodiments, the outer tube 210, the inner tubes 220, and/or the nested tubes 230 may include silica glass and/or silica-based glass (i.e., silica glass comprising one or more dopants).

### Fiber Drawing System

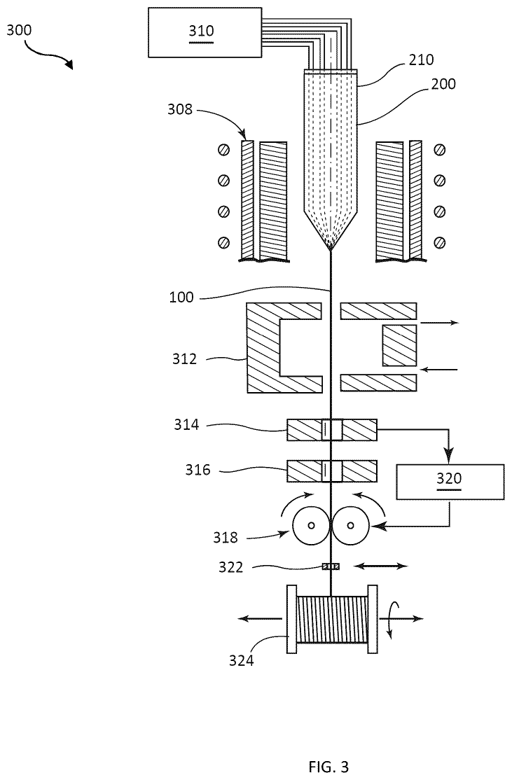

FIG. 3 schematically depicts an example of a drawing system 300 that may be utilized to produce the hollow-core optical fiber 100 from the hollow-core preform 200.

In some embodiments, the drawing system 300 may include a draw furnace 308 configured for receiving and heating the hollow-core preform 200, thereby subjecting the hollow-core preform 200 to a draw temperature. After, and as, the hollow-core preform 200 is subjected to the draw temperature, the hollow-core preform 200 may be necked down, and the hollow-core optical fiber 100 may be drawn from the hollow-core preform 200. The draw furnace 308 may include a hot zone, which is defined as the axial span of the heating elements that are used to heat up the preform for drawing into fiber. An axial length of the hot zone may be greater than or equal to (i.e., ≥) 3 cm and less than or equal to (i.e., ≤) 50 cm—including all sub-ranges or values therebetween. For example, in some embodiments, the axial length of the hot zone may be ≥3 cm and ≤50 cm, ≥3 cm and ≤40 cm, ≥3 cm and ≤30 cm, ≥3 cm and ≤20 cm, ≥3 cm and ≤10 cm, ≥10 cm and ≤50 cm, ≥10 cm and ≤40 cm, ≥10 cm and ≤30 cm, ≥10 cm and ≤20 cm, ≥20 cm and <50 cm, ≥20 cm and ≤40 cm, ≥20 cm and ≤30 cm, ≥30 cm and ≤50 cm, ≥30 cm and ≤40 cm, or ≥40 cm and ≤50 cm. In some embodiments, the axial length of the hot zone may be ≥3 cm, ≥5 cm, ≥10 cm, ≥15 cm, ≥20 cm, ≥25 cm, ≥30 cm, ≥35 cm, ≥40 cm, ≥45 cm, or greater. In some embodiments, the axial length of the hot zone may be ≤50 cm, ≤45 cm, ≤40 cm, ≤35 cm, ≤30 cm, ≤25 cm, ≤20 cm, ≤15 cm, ≤10 cm, ≤5 cm, or less.

In some embodiments, the drawing system 300 may further include a pressure control system 310. The pressure control system 310 may be coupled to and configured for pressuring the interior cavities of the outer tube 210, the inner tubes 220, and/or the nested tubes 230 (if present) of the hollow-core preform 200. In some embodiments, the pressure control system 310 may include any or all of a pressure sensor, a vacuum system, a gas pressure source or gas supply, and/or a controller for monitoring the pressure(s) within the various cavities mentioned above and using vacuum and/or gas pressure to maintain the pressure(s) at a desired value(s). In some embodiments, the pressure control system 310 may include a manifold connected to the gas pressure source or gas supply for supplying gas to the hollow-core preform 200. The pressure(s) within the cavities mentioned above may at least in part determine the dimensions, such as radii, of the outer cladding 110, the capillaries 120, and/or the nested capillaries 130 of the hollow-core optical fiber 100, as will be discussed in more detail below.

In some embodiments, the drawing system 300 may further include a cooling chamber 312 to cool the hollow-core optical fiber 100. In some embodiments, the drawing system 300 may further include a non-contact sensor 314 for measuring the dimension, e.g., diameter of the outer surface 112 of the outer cladding 110. In some embodiments, the drawing system 300 may further include a coating apparatus 316 for applying and/or curing one or more coatings over the outer cladding 110.

In some embodiments, the drawing system 300 may further include a tension assembly 318, such as tractor, for applying a draw tension to draw the hollow-core optical fiber 100 from the hollow-core preform 200. The draw tension may be controlled via a control apparatus 320 to at least in part maintain the dimension of the hollow-core optical fiber 100 at a predetermined set point. In some embodiments, the drawing system 300 may further include a feedhead 322 for winding the hollow-core optical fiber 100 onto a storage spool 324.

### Processing Preforms of Various Sizes

### (a) Finite Analytical Solution of Evolution of Preform Dimensions During Drawing

As discussed above, during the drawing of the hollow-core optical fiber, the hollow-core preform may be necked down, and the dimensions, e.g., the inner diameter/radius and outer diameter/radius, of the outer tube in the neckdown region evolve as they are subject to forces of surface tension, core pressure, and draw tension. The neckdown region refers to the region of the hollow-core preform between the axial location where the dimension(s) of the hollow-core preform, e.g., the outer diameter of the hollow-core preform, begins to reduce and the axial location where the final dimension(s), e.g., the outer diameter of the hollow-core optical fiber, is reached.

The evolution of the outer radius, R, and the inner radius, r, of the outer tube in the neckdown region is given by the following relation:

$$\frac{d}{dz} ( {r}^{2} {V}_{z} ) = \frac{d}{dz} ( {R}^{2} {V}_{z} ) = \frac{{P}_{core} {r}^{2} {R}^{2} - σ rR ( r + R )}{μ ( {R}^{2} - {r}^{2} )} \qquad [ 1 ]$$

where z is the axial distance in the neckdown region, V_{z} is the axial velocity, P_{core} is the differential core pressure, σ is the surface energy of the glass material forming the outer tube (e.g., 300 dynes/cm for silica glass), and μ is the glass viscosity. The surface energy can be measured using the method described in Glass Engineering Handbook, 2nd Edition, by Shand, E. B.; Greene, C. H.; Grant, J. A.; Armistead, W. H., the content of which is incorporated by reference herein. The differential core pressure P_{core}, which may also be referred to as the gauge pressure P_{core}, is defined as the pressure difference between the pressure inside the interior cavity of the outer tube of the hollow-core preform and the atmospheric pressure around the exterior of the outer tube of the hollow-core preform.

The draw tension under which the hollow-core optical fiber may be drawn from the hollow-core preform is given as:

$$T = 3 μ \frac{d ( {V}_{Z} )}{dz} π ( {R}^{2} - {r}^{2} ) \qquad [ 2 ]$$

Using a Corrocco type transformation and using Equation [2] to transform Equation Eq. [1] with axial velocity as the independent variable, the following is obtained:

$$\frac{d}{{dV}_{z}} ( r ) = \frac{3 π ( {P}_{core} {rR}^{2} - σ R ( R + r ) )}{2 {TV}_{z}} - \frac{r}{2 {V}_{z}} \qquad [ 3 a ]$$

$$\frac{d}{{dV}_{z}} ( R ) = \frac{3 π ( {P}_{core} {Rr}^{2} - σ r ( R + r ) )}{2 {TV}_{z}} - \frac{R}{2 {V}_{z}} \qquad [ 3 b ]$$

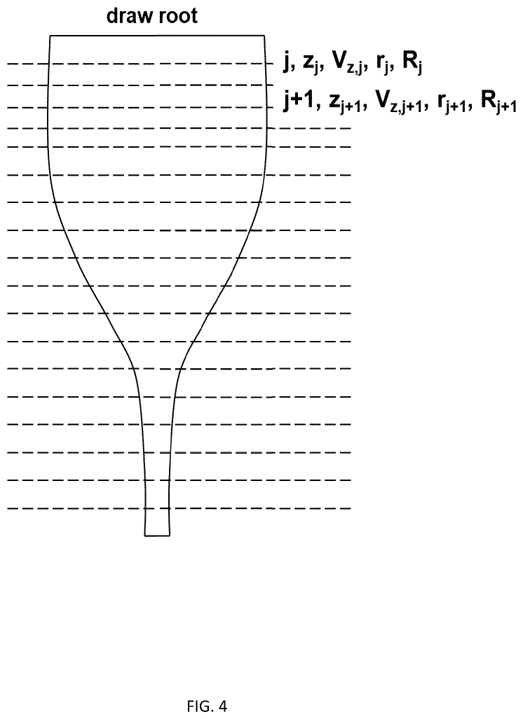

To capture the evolution of the outer radius R and the inner radius r of the outer tube of the hollow-core preform in the neckdown region, a finite-analytic solution, as shown in FIG. 4, is implemented, where the analytic solution between the ith and the (i+1) the node is given as:

$${r}_{j + 1} = ( \frac{3 π {R}_{j}^{2} σ}{T + 3 π {R}_{j} σ - 3 π {P}_{core} {R}_{j}^{2}} ) + ( {r}_{j} - \frac{3 π {R}_{j}^{2} σ}{T + 3 π {R}_{j} σ - 3 π {P}_{core} {R}_{j}^{2}} ) {( \frac{{V}_{z , j + 1}}{{V}_{z , j}} )}^{- ( τ + 3 π {R}_{j} σ - 3 π {P}_{core} {R}_{j}^{2} ) / 2 T} \qquad [ 4 a ]$$

$${R}_{j + 1} = ( \frac{3 π {r}_{j}^{2} σ}{T + 3 π {r}_{j} σ - 3 π {P}_{core} {r}_{j}^{2}} ) + ( {R}_{j} - \frac{3 π {r}_{j}^{2} σ}{T + 3 π {r}_{j} σ - 3 π {P}_{core} {r}_{j}^{2}} ) {( \frac{{V}_{z , j + 1}}{{V}_{z , j}} )}^{- ( τ + 3 π {r}_{j} σ - 3 π {P}_{core} {r}_{j}^{2} ) / 2 T} \qquad [ 4 b ]$$

which can be implemented with the mass balance equation as:

$${V}_{z , j + 1} ( {R}_{j + 1}^{2} - {r}_{j + 1}^{2} ) = {V}_{z , j} ( {R}_{j}^{2} - {r}_{j}^{2} ) \qquad [ 5 ]$$

### (i) Exemplary Implementations of the Finite-Analytic Solution

The finite-analytic solution was implemented for different preform geometries that resulted in the same microstructure for the hollow-core optical fiber, such as the same inner diameter of the outer cladding of the hollow-core fiber (ID_{Fiber}=2×r_{f}) of about 79.7 μm, and the same outer diameter of the outer cladding of the hollow-core optical fiber (OD_{fiber}=2×R_{f}) of about 249 μm. However, it should be noted that the present disclosure is not limited to these specific fiber target dimensions (i.e., inner diameter of 79.7 μm and outer diameter of 249 μm), which are used for non-limiting illustrative purposes. The present disclosure may be implemented for achieving other target dimensions of the hollow-core optical fiber from different preform dimensions. For example, the solution described herein may be utilized for achieving any target inner diameter of the outer cladding of the hollow-core optical fiber that may be greater than or equal to (i.e., ≥) 45 μm and less than or equal to (i.e., ≤) 145 μm—including all sub-ranges or values therebetween. Similarly, the solution described herein may also be utilized for achieving any target outer diameter of the outer cladding of the hollow-core optical fiber that may be greater than or equal to (i.e., ≥) 150 μm and less than or equal to (i.e., ≤) 300 μm—including all sub-ranges or values therebetween.

Table 1 below shows that different combinations of pressure, draw tension, and preform geometries that result in substantially the same inner and outer diameters of the outer cladding of the hollow-core optical fiber. As shown in Table 1, the various outer diameters of the outer tube of the hollow-core preform (OD_{preform}=2×Rₚ) between 17 mm and 50 mm and the various inner diameters of the outer tube of the hollow-core preform (ID_{Preform}=2×rₚ) between 5 mm and 9 mm result in substantially the same microstructures of the hollow-core optical fiber, with the fiber draw speeds ranging between 1 m/s and 10 m/s.

TABLE 1

| | | | | | | | | | Fiber |
|---|---|---|---|---|---|---|---|---|---|
| | Preform | Preform | Fiber | Fiber | | Differential | Preform | Fiber | Draw |
| | OD, | ID, | OD, | ID, | Draw | Core | Feed | Draw | Speed, |
| | 2 × Rₚ | 2 × rₚ | 2 × R_{f} | 2 × r_{f} | Tension, | Pressure, | Rate, Vₚ | Rate, V_{f} | V_{f}/60000 |
| Ex | (mm) | (mm) | (um) | (um) | τ (g) | P_{core} (psig) | (mm/min) | (mm/min) | (m/sec) |
| 1 | 17.25 | 5 | 248.5 | 79.72 | 100 | 0.014 | 12.5 | 60000 | 1.00 |
| 2 | 17.25 | 5 | 249.4 | 79.67 | 150 | 0.032 | 12.5 | 60000 | 1.00 |
| 3 | 17.25 | 5 | 249.85 | 79.64 | 200 | 0.05 | 12.5 | 60000 | 1.00 |
| 4 | 17.25 | 5 | 250.12 | 79.71 | 250 | 0.069 | 12.5 | 60000 | 1.00 |
| 5 | 17.25 | 5 | 250.32 | 79.69 | 300 | 0.087 | 12.5 | 60000 | 1.00 |
| 6 | 25.875 | 7 | 246.96 | 79.73 | 100 | 0.013 | 12.5 | 136858.2 | 2.28 |
| 7 | 25.875 | 7 | 248.625 | 79.625 | 150 | 0.027 | 12.5 | 136857.4 | 2.28 |
| 8 | 25.875 | 7 | 248.99 | 79.81 | 200 | 0.04 | 12.5 | 136857 | 2.28 |
| 9 | 25.875 | 7 | 249.3775 | 79.74 | 250 | 0.056 | 12.5 | 136856.8 | 2.28 |
| 10 | 25.875 | 7 | 249.63 | 79.69 | 300 | 0.07 | 12.5 | 136856.6 | 2.28 |
| 11 | 34.6 | 8 | 246.99 | 79.72 | 100 | 0.018 | 12.5 | 247134.8 | 4.12 |
| 12 | 34.6 | 8 | 248.719 | 79.72 | 150 | 0.0335 | 12.5 | 247132.8 | 4.12 |
| 13 | 34.6 | 8 | 249.6 | 79.89 | 200 | 0.049 | 12.5 | 247131.8 | 4.12 |
| 14 | 34.6 | 8 | 250.08 | 79.77 | 250 | 0.064 | 12.5 | 247130.2 | 4.12 |
| 15 | 34.6 | 8 | 250.04 | 79.688 | 300 | 0.079 | 12.5 | 247130.8 | 4.12 |
| 16 | 49.6 | 9 | 246.42 | 79.63 | 100 | 0.0157 | 12.5 | 512464.3 | 8.54 |
| 17 | 49.6 | 9 | 248.74 | 79.82 | 150 | 0.0287 | 12.5 | 512458.3 | 8.54 |
| 18 | 49.6 | 9 | 249.88 | 79.78 | 200 | 0.0415 | 12.5 | 512455.3 | 8.54 |
| 19 | 49.6 | 9 | 250.58 | 79.77 | 250 | 0.0543 | 12.5 | 512453.4 | 8.54 |
| 20 | 49.6 | 9 | 251.03 | 79.706 | 300 | 0.067 | 12.5 | 512452.2 | 8.54 |

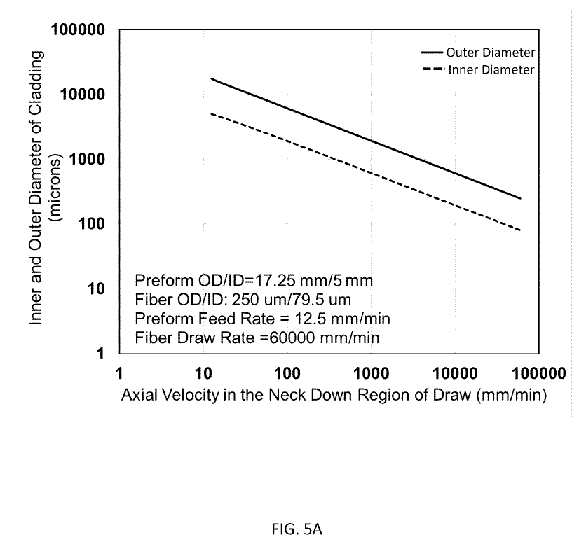

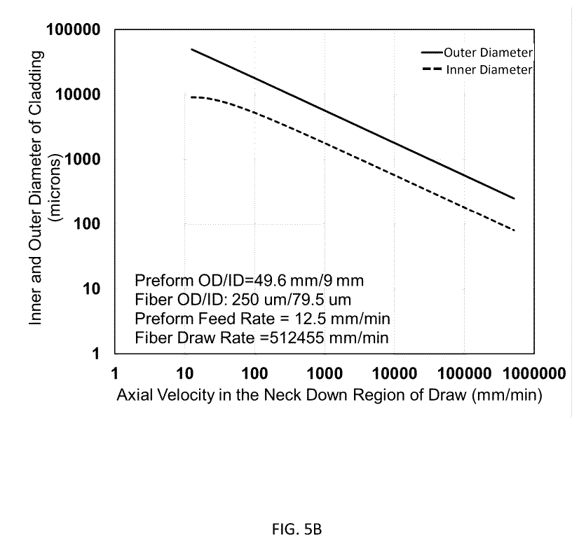

FIGS. 5A and 5B show the evolution of the outer diameter (OD) and the inner diameter (ID) of the outer tube of the hollow-core preform as a function of the axial draw velocity in the neckdown region during the drawing. The outer tubes of the hollow-core preforms in FIGS. 5A and 5B have different outer and inner diameters (OD/ID) ((A) 17.25 mm/5 mm and (B) 49.6 mm/9 mm), but yield identical outer cladding dimensions (OD/ID) of the hollow-core optical fibers drawn (250 μm/79.6 μm). Both hollow-core optical fibers are drawn with the same draw tension τ of 200 g. The hollow-core preforms are fed at the same preform feed rate of 12.5 mm/min, and the hollow-core optical fibers are drawn at different fiber draw rates of (A) 60,000 mm/min and (B) 512,455 mm/min.

Table 2 below shows the sensitivity of the ratio of the inner radius of the outer cladding of the hollow-core optical fiber to the inner radius of the outer tube of the hollow-core preform (r_{f}/rₚ) to the ratio of the preform feed rate and the fiber draw rate (V_{f}/Vₚ), as well as the sensitivity of the ratio of the outer radius of the outer cladding of the hollow-core optical fiber to the outer radius of the outer tube of the hollow-core preform (R_{f}/Rₚ) to the ratio of the preform feed rate and the fiber draw rate (V_{f}/Vₚ).

TABLE 2

| Ex | V_{f}/Vₚ | r_{f}/rₚ | R_{f}/Rₚ | ln(V_{f}/Vₚ) | ln(r_{f}/rₚ) | ln(R_{f}/Rₚ) | m = ln(r_{f}/rₚ)/ln(V_{f}/Vₚ) | n = ln(R_{f}/Rₚ)/ln(V_{f}/Vₚ) |
|---|---|---|---|---|---|---|---|---|
| 1 | 4800.0 | 0.0159 | 0.0144 | 8.476 | −4.139 | −4.240 | −0.488 | −0.500 |
| 2 | 4800.0 | 0.0159 | 0.0145 | 8.476 | −4.139 | −4.237 | −0.488 | −0.500 |
| 3 | 4800.0 | 0.0159 | 0.0145 | 8.476 | −4.140 | −4.235 | −0.488 | −0.500 |
| 4 | 4800.0 | 0.0159 | 0.0145 | 8.476 | −4.139 | −4.234 | −0.488 | −0.499 |
| 5 | 4800.0 | 0.0159 | 0.0145 | 8.476 | −4.139 | −4.233 | −0.488 | −0.499 |
| 6 | 10948.7 | 0.0114 | 0.0095 | 9.301 | −4.475 | −4.652 | −0.481 | −0.500 |
| 7 | 10948.6 | 0.0114 | 0.0096 | 9.301 | −4.476 | −4.645 | −0.481 | −0.499 |
| 8 | 10948.6 | 0.0114 | 0.0096 | 9.301 | −4.474 | −4.644 | −0.481 | −0.499 |
| 9 | 10948.5 | 0.0114 | 0.0096 | 9.301 | −4.475 | −4.642 | −0.481 | −0.499 |
| 10 | 10948.5 | 0.0114 | 0.0096 | 9.301 | −4.476 | −4.641 | −0.481 | −0.499 |
| 11 | 19770.8 | 0.0100 | 0.0071 | 9.892 | −4.609 | −4.942 | −0.466 | −0.500 |
| 12 | 19770.6 | 0.0100 | 0.0072 | 9.892 | −4.609 | −4.935 | −0.466 | −0.499 |
| 13 | 19770.5 | 0.0100 | 0.0072 | 9.892 | −4.607 | −4.932 | −0.466 | −0.499 |
| 14 | 19770.4 | 0.0100 | 0.0072 | 9.892 | −4.608 | −4.930 | −0.466 | −0.498 |
| 15 | 19770.5 | 0.0100 | 0.0072 | 9.892 | −4.609 | −4.930 | −0.466 | −0.498 |
| 16 | 40997.1 | 0.0088 | 0.0050 | 10.621 | −4.728 | −5.305 | −0.445 | −0.499 |
| 17 | 40996.7 | 0.0089 | 0.0050 | 10.621 | −4.725 | −5.295 | −0.445 | −0.499 |
| 18 | 40996.4 | 0.0089 | 0.0050 | 10.621 | −4.726 | −5.291 | −0.445 | −0.498 |
| 19 | 40996.3 | 0.0089 | 0.0051 | 10.621 | −4.726 | −5.288 | −0.445 | −0.498 |
| 20 | 40996.2 | 0.0089 | 0.0051 | 10.621 | −4.727 | −5.286 | −0.445 | −0.498 |

The inventors have recognized that the inner radius of the outer cladding of the hollow-core optical fiber drawn, r_{f}, can be more sensitive to select drawing parameters, e.g., the preform dimensions (e.g., increased preform inner radius rₚ and/or outer radius Rₚ) and/or the fiber draw rate V_{f}, than the outer radius of the outer cladding of the hollow-core optical fiber drawn, R_{f}, as suggested by the greater variation in value m=ln(r_{f}/rₚ)/ln(V_{f}/Vₚ) than in value n=ln(R_{f}/Rₚ)/ln(V_{f}/Vₚ) from example 1 to example 20. Accordingly, when preform size and/or fiber draw rate may be increased to scale up production, the present disclosure provides the drawing parameters, such as the preform dimensions (e.g., preform inner and outer radii rₚ and Rₚ), fiber draw rate/speed, draw tension, core pressure, etc., and solutions (e.g., finite analytical solution, as well as approximate solution discussed below) for selecting these drawing parameters so that target microstructure dimensions of the fiber (e.g., fiber inner and outer radii r_{f} and R_{f}, especially the inner radius r_{f}) can be achieved consistently, as shown by examples 1-20.

### (b) Approximate Solution of Preform Outer Tube Dimensions

Based on the example shown in Table 1, the following relations can be approximated for the differential core pressure P_{core} as a function of draw tension τ in grams:

$${P}_{core} ( psig ) ∼ 1.877 \times 1 {0}^{- 5} \times {τ}^{1.46} \qquad [ 6 ]$$

Further, the following relations can be approximated for the inner radius rₚ and the outer radius Rₚ of the outer tube of the hollow-core preform:

$${r}_{p} ∼ \frac{{r}_{f}}{{( {V}_{f} / {V}_{p} )}^{- ( T + 3 π {R}_{*} σ - 3 π {P}_{core} {R}_{*}^{2} ) / 2 T}} \qquad [ 7 a ]$$

$${R}_{p} ∼ \frac{{R}_{f}}{{( {V}_{f} / {V}_{p} )}^{- ( T + 3 π {r}_{*} σ - 3 π {P}_{core} {r}_{*}^{2} ) / 2 T}} \qquad [ 7 b ]$$

where r_{f} and R_{f} are the inner and outer radii, respectively, of the outer cladding of the hollow-core optical fiber, Vₚ is the hollow-core preform feed rate, V_{f} is the hollow-core fiber draw rate, T is the draw tension in dynes and T=τ*981, σ is the surface energy of the glass material forming the outer tube of the hollow-core preform (e.g., 300 dynes/cm for silica glass), and r* and R* are given as:

$${r}_{*} ∼ 5 \sqrt{{r}_{p} {r}_{f}} \qquad [ 8 a ]$$

$${R}_{*} ∼ 5 \sqrt{{R}_{p} {R}_{f}} \qquad [ 8 b ]$$

Based on the approximate solutions above, the inventors have found that when the differential core pressure P_{core} satisfies the following relation:

$$0 \text{.8} \times P * < {P}_{core} < 1 \text{.2} \times P * \qquad [ 9 ]$$

where P*=1.877×10⁻⁵×τ^{1.46}, consistent target inner radius r_{f} and consistent target outer radius R_{f} of the outer cladding of the hollow-core optical fiber can be achieved with preforms having outer tuber inner radius rₚ and outer tube outer radius Rₚ that satisfy the following relations:

$$0.9 \times {r}_{p}^{*} < {r}_{p} < 1.1 \times {r}_{p}^{*} \qquad [ 10 a ]$$

$$0.95 \times {R}_{p}^{*} < {R}_{p} < 1.05 \times {R}_{p}^{*} \qquad [ 10 b ]$$

$${r}_{p}^{*} = \frac{{r}_{f}}{{( {V}_{f} / {V}_{p} )}^{- ( T + 3 π {R}_{*} σ - 3 π {P}_{core} {R}_{*}^{2} ) / 2 T}} \qquad [ 11 a ]$$

$${R}_{p}^{*} = \frac{{R}_{f}}{{( {V}_{f} / {V}_{p} )}^{- ( T + 3 π {r}_{*} σ - 3 π {P}_{core} {r}_{*}^{2} ) / 2 T}} \qquad [ 11 b ]$$

$$and$$

$${r}_{*} = 5 \sqrt{{r}_{p}^{*} {r}_{f}} \qquad [ 12 a ]$$

$${R}_{*} = 5 \sqrt{{R}_{p}^{*} {R}_{f}} \qquad [ 12 b ]$$

### Improving Process Stability

As discussed above, scale-up manufacturing of the hollow-core optical fiber may be achieved by, for example, increasing the size of the hollow-core preform while still achieving the same or similar target microstructures of the hollow-core optical fiber. To further limiting any variation in the dimensions of the hollow-core optical fiber that may be affected due to change in process conditions, the process parameters may be selected such that variations in fiber dimensions due to process induced perturbations, e.g., inherent fluctuations in the differential core pressure P_{core}, may be limited such that longer length fibers with target dimensions may be achieved. In some embodiments, tight control in target fiber dimensions may be achieved through selecting appropriate dimensions of the incoming preform to be used for drawing, selecting appropriate dimensions of the fiber to be drawn, and/or selecting appropriate drawing conditions, such as draw tension, draw stress, preform feed rate, fiber draw rate, etc.

For a given incoming preform, the law of conservation of mass of glass fed through the draw furnace dictates the following:

$$[ O {D}_{preform}^{2} - I {D}_{preform}^{2} ] {V}_{p} = [ O {D}_{fiber}^{2} - I {D}_{fiber}^{2} ] {V}_{f} \qquad [ 13 ]$$

where OD_{preform}=2×Rₚ is the outer diameter of the outer tube of the hollow-core preform, ID_{preform}=2×rₚ is the inner diameter of the outer tube of the hollow-core preform, Vₚ is the preform feed rate, OD_{fiber}=2×R_{f} is the outer diameter of the outer cladding of the hollow-core optical fiber, ID_{fiber}=2×r_{f} is the inner diameter of the outer cladding of the hollow-core optical fiber, and V_{f} is the fiber draw rate.

The inventors have also derived the following relation:

$$I {D}_{fiber} = sqrt [ \frac{( O {D}_{preform}^{2} - I {D}_{preform}^{2} ) \times ( {V}_{p} / {V}_{f} )}{exp \{ ln \frac{O {D}_{preform}^{2}}{I {D}_{preform}^{2}} - \frac{3 π}{4} \times {P}_{core} \times \frac{3 π}{4} \times {P}_{core} \times ( O {D}_{preform}^{2} - I {D}_{preform}^{2} ) \times ( 1 - \frac{{V}_{p}}{{V}_{f}} ) \times \frac{1}{τ} \} - 1} ] \qquad [ 14 ]$$

where P_{core} is the differential core pressure, which also correspond to the centerline pressure applied to the interior cavity of the outer tube of the hollow-core preform, and τ is the draw tension.
(a) Process Scale-Up with Constant Draw Ratio to Draw Fibers with Same ID_{fiber} and Same OD_{fiber} from Varying ID_{preform} and Varying OD_{preform}

Through processing modeling, fiber dimension sensitivity to exemplary process parameters is examined and results are shown in Tables 3A and 3B below. In each modeled process/run, same dimensions of the outer cladding of the hollow-core optical fiber are targeted, i.e., same inner diameter of the outer cladding of the hollow-core optical fiber, ID_{fiber}=90.0 μm, and same outer diameter of the outer cladding of the hollow-core optical fiber, OD_{fiber}=175.4 μm. Hollow-core preforms of different sizes are modeled for different yields. For each preform, two different draw tensions, i.e., 150 g and 250 g, are considered, which correspond to two different draw stress levels, i.e., draw stress of 82.66 MPa and draw stress of 137.77 MPa, respectively, which are calculated based on the following:

$$Draw Stress , x = \frac{4}{π} \times \frac{τ}{( O {D}_{fiber}^{2} - I {D}_{fiber}^{2} )} \qquad [ 15 ]$$

where τ is the draw tension applied to the fiber, OD_{fiber} is the outer diameter of the outer cladding of the hollow-core optical fiber drawn, and ID_{fiber} is the inner diameter of the outer cladding of the hollow-core optical fiber drawn. The data associated with the draw tension of 150 g are shown Table 3A, and the data associated with the draw tension of 250 g are shown in Table 3B.

The preform feed rate Vₚ is varied at multiples of 5 mm/min, and the fiber draw rate V_{f} is varied at multiples of 30,000 mm/min; however, the draw ratio, i.e., the ratio of the preform feed rate Vₚ to the fiber draw rate V_{f} (Vₚ:V_{f}), is kept constant at 1:6,000. It is noted that other process conditions, e.g., differential core pressure P_{core}, are varied such that the same target fiber dimensions ID_{fiber} and OD_{fiber} are achieved from the various incoming preforms.

TABLE 3A

| Label | Preform 1 | Preform 2 | Preform 3 | Fiber |
|---|---|---|---|---|
| OD_{preform} (mm) | 12.5 | 17.5 | 25.0 | / |
| ID_{preform} (mm) | 4.5 | 5.0 | 5.0 | / |
| OD_{fiber} (μm) | / | / | / | 175.4 |
| ID_{fiber} (μm) | / | / | / | 90.0 |
| Yield (in km per m) | 6.00 | 12.41 | 26.47 | / |
| Draw Tension (g) | / | / | / | 150 |
| Draw Stress (MPa) | / | / | / | 82.66 |
| Differential core pressure | 0.47 | 0.19 | 0.09 | / |
| P_{core} (psig) | | | | |
| ID_{fiber} Sensitivity, | 0.931 | 1.923 | 3.985 | / |
| ΔID_{fiber} (μm) | | | | |

TABLE 3B

| Label | Preform 1 | Preform 2 | Preform 3 | Fiber |
|---|---|---|---|---|
| OD_{preform} (mm) | 12.5 | 17.5 | 25.0 | / |
| ID_{preform} (mm) | 4.5 | 5.0 | 5.0 | / |
| OD_{fiber} (μm) | / | / | / | 175.4 |
| ID_{fiber} (μm) | / | / | / | 90.0 |
| Yield (in km per m) | 6.00 | 12.41 | 26.47 | / |
| Draw Tension (g) | / | / | / | 250 |
| Draw Stress (MPa) | / | / | / | 137.77 |
| Differential core pressure | 0.79 | 0.32 | 0.16 | / |
| P_{core} (psig) | | | | |
| ID_{fiber} Sensitivity, | 0.557 | 1.147 | 2.365 | / |
| ΔID_{fiber} (μm) | | | | |

The fiber dimension sensitivity is evaluated in terms of the change in the inner diameter of the outer cladding of the hollow-core optical fiber (from 90.0 μm), ΔID_{fiber}, as the differential core pressure P_{core} undergoes a 0.01 psig fluctuation, more specifically, an increase of 0.01 psig, using equation [14] provided above. It is noted that by maintaining the same feed to draw ratio (Vₚ:V_{f}), for a given preform, the same fiber dimension sensitivity ΔID_{fiber} results.

As shown in Tables 3A and 3B, respectively, when the same draw tension is applied, the fiber dimension sensitivity increases as the preform size increases for higher yields. Comparing the results in Tables 3A and 3B, for the same preform, fiber dimension sensitivity may be reduced by increasing the draw tension. Thus, as the preform size decreases and/or the draw stress increases such as when greater draw tension is applied, a lesser degree of variation in the inner diameter of the outer cladding of the hollow-core optical fiber (or fiber dimension sensitivity ΔID_{fiber}) may be achieved as the differential core pressure P_{core} undergoes the same fluctuation.

(b) Process Scale-Up with Varied Draw Ratios to Draw Fibers with Same ID_{fiber} and Varying OD_{fiber} from Same ID_{preform} and Varying OD_{preform}

Additional exemplary fiber draw processes/runs are modeled, where the same inner diameter of the outer cladding of the hollow-core optical fiber, i.e., ID_{fiber}=90.0 μm, is targeted while the outer diameter of the outer cladding of the hollow-core optical fiber OD_{fiber} is varied. The inner diameter of the outer tube of the hollow-core preform ID_{preform} is kept at about 5.0 mm while the outer diameter of the outer tube of the hollow-core preform OD_{preform} is varied. The differential core pressure P_{core} needed to achieve the ID_{fiber} of 90.0 μm from different preform sizes is obtained based on equation [14] above and also shown in Table 4 below. The following process conditions are maintained for different runs: preform feed speed Vₚ=5 mm/min, fiber draw speed V_{f}=30000 mm/min, and operating draw tension of 150 g.

TABLE 4

| PREFORM OD | PREFORM ID | Differential Core |
|---|---|---|
| [mm] | [mm] | Pressure P_{core} [psig] |
| 12.5 | 4.5 | 0.36 |
| 17.5 | 5.0 | 0.19 |
| 25.0 | 5.0 | 0.09 |
| 50.0 | 5.0 | 0.02 |
| 75.0 | 5.0 | 0.01 |
| 100.0 | 5.0 | 0.01 |

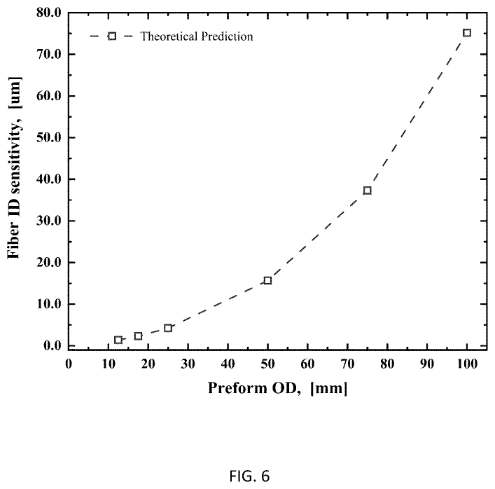

Fiber dimension sensitivity, more specifically, deviation in the inner diameter of the outer cladding of the hollow-core optical fiber (from 90.0 μm), ΔID_{fiber}, is modeled when the core pressure is increased by 0.01 psig, i.e., ΔP_{core}=0.01 psig. FIG. 6 is a plot of the sensitivity of the inner diameter of the outer cladding of the hollow-core optical fiber (“Fiber ID sensitivity, [μm]”) as a function of the outer diameter of the outer tube of the preform (“Preform OD, [mm]”).

As shown in FIG. 6, the fiber dimension sensitivity, ΔID_{fiber}, increases as the outer diameter OD_{preform} of the outer tube of the hollow-core preform increases. As shown in Table 4, with increasing thickness of the outer tube of the hollow-core preform, the differential core pressure P_{core} needed to achieve the same target inner diameter of the outer cladding of the hollow-core optical fiber ID_{fiber} of 90.0 μm is decreased. Thus, the effects of the fluctuation in core pressure (ΔP_{core}=0.01 psig) becomes more significant such that it can induce much greater change in the inner diameter of the outer cladding of the hollow-core optical fiber, ΔID_{fiber}, as highlighted in FIG. 6.

### (c) Dependence of Fiber Dimension Sensitivity×Thickness Squared on Draw Stress

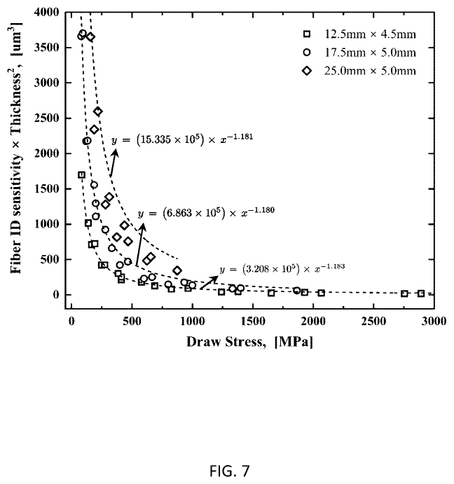

Additional exemplary fiber draw processes/runs are modeled to analyze the relationship between the fiber dimension sensitivity and the draw stress. The following are implemented for these draw processes/runs: the same inner diameter of the outer cladding of the hollow-core optical fiber, i.e., ID_{fiber}=90.0 μm, is targeted while the outer diameter of the outer cladding of the hollow-core optical fiber is varied; preforms of three different sizes are considered (OD_{preform} and ID_{preform} of 12.5 mm and 4.5 mm, 17.5 mm and 5.0 mm, and 25.0 and 5 mm, respectively); the fiber draw rate V_{f} is varied from 30,000 mm/min to 600,000 mm/min while the preform feed rate Vₚ is kept constant (Vₚ=5 mm/min); various draw tension τ levels (150 g, 250 g, and 350 g) are considered so that a wide range of draw stress levels are examined. The differential core pressure P_{core} needed to achieve the target ID_{fiber} of 90.0 μm is calculated based on equation above. The modeling analysis of these draw processes/runs is reflected in FIG. 7, which plots the fiber dimension sensitivity ΔID_{fiber} (i.e., variation in the inner diameter of the outer cladding of the hollow-core fiber due to differential core pressure fluctuation ΔP_{core} of 0.1 psig) multiplied by the square of the thickness of the outer cladding of the hollow-core optical fiber (i.e., (OD_{fiber}−ID_{fiber})²) (“Fiber ID sensitivity×Thickness², [μm³]”) as a function of draw stress (“Draw Stress, [MPa]).

Based on the modeling analysis shown in FIG. 7, a relation between the fiber dimensional term (“Fiber ID sensitivity×Fiber Thickness²”) and the operating draw stress can be derived as follows for drawing a hollow-core optical fiber of which the inner diameter of the outer cladding is 90.0 μm:

$$y = A \times ( 3.208 \times 1 {0}^{5} ) \times {x}^{- 1.18} \qquad [ 16 ]$$

where x is the operating draw stress that is estimated using equation [15], y is the fiber dimensional term “Fiber ID sensitivity×Fiber Thickness²”, i.e.,

$$y = Δ I {D}_{fiber} \times Fiber {Thickness}^{2} \qquad [ 17 ]$$

where Fiber Thickness refers to the thickness of the outer cladding of the hollow-core optical fiber as defined by the difference between the outer radius R_{f}=½ OD_{fiber} and the inner radius r_{f}=½ ID_{fiber} of the outer cladding, and thus, Fiber Thickness=R_{f}−r_{f}=½ OD_{fiber}−½ ID_{fiber}, and A is a scaling factor that correlates with the cross-sectional area of incoming preform scaled by the cross-sectional area of an outer tube having an outer diameter OD_{preform} of 12.5 mm and an inner diameter ID_{preform} of 4.5 mm, and thus,

$$A = \frac{O {D}_{preform}^{2} - I {D}_{preform}^{2}}{12 . {5}^{2} - 4 . {5}^{2}} = \frac{O {D}_{preform}^{2} - I {D}_{preform}^{2}}{136} \qquad [ 18 ]$$

Table 5 below provides the scaling factor A for various preform sizes.

TABLE 5

| OD_{preform} [mm] | ID_{preform} [mm] | SCALING FACTOR, A |
|---|---|---|
| 12.5 | 4.5 | 1.000 |
| 17.5 | 5.0 | 2.068 |
| 25.0 | 5.0 | 4.412 |
| 50.0 | 5.0 | 18.199 |
| 75.0 | 5.0 | 41.176 |
| 100.0 | 5.0 | 73.346 |

Combining equations [16], [17], and [18], the following is obtained:

$$Δ I {D}_{fiber} = \frac{O {D}_{preform}^{2} - I {D}_{preform}^{2}}{34 \times {( O {D}_{fiber} - I {D}_{fiber} )}^{2}} \times ( 3.208 \times 1 {0}^{5} ) \times {x}^{- 1.18} \qquad [ 19 ]$$

Using equations [16]-[19], the fiber dimension sensitivity, more specifically, ΔID_{fiber}, to the core pressure fluctuation of ΔP_{core}=0.01 psig can be obtained for any operating draw stress when using various preforms for drawing a hollow-core optical fiber where the targeted inner diameter of the outer cladding of the hollow-core optical fiber is 90.0 μm.

Referring back to the modeling analysis shown in FIG. 7, when different fibers are drawn from the same hollow-core preform, it is observed that for the same operating draw stress, a thicker outer cladding of the hollow-core optical fiber may lead to a lower fiber dimension sensitivity ΔID_{fiber} as compared to a thinner outer cladding. Thus, it may be desirable to draw fibers having thicker outer claddings to reduce fiber dimension sensitivity ΔID_{fiber}. However, drawing fibers with thicker outer claddings may require greater draw tension, which may pose other challenges during the drawing process when the draw tension becomes too high. Thus, appropriate draw tension, e.g., greater than or equal to (i.e., ≥) 50 g and less than or equal to (i.e., ≤) 600 g, may be selected for optimal drawing conditions to minimize the fiber dimension sensitivity ΔID_{fiber}.

Additionally, as also shown in FIG. 7, when different preforms are used for scaling up, fiber dimension sensitivity ΔID_{fiber} may increase as the thickness of the outer tube of the preform increases, especially at relatively small draw stress levels. Therefore, when drawing from a preform having a relatively thick outer tube for longer fiber production, relatively high draw stress levels may be implemented to maintain a tight control on the target fiber dimensions, such as the target inner diameter ID_{fiber} of the outer cladding of the hollow-core optical fiber drawn. When drawing from a preform having a thinner outer tube, smaller draw stress levels may be implemented while still maintaining a tight control over the target fiber dimensions.

### (d) Dependence of Fiber Dimension Sensitivity on Grouping Parameter Θ

Further exemplary fiber draw processes/runs are modeled to analyze the fiber dimension sensitivity. The following are implemented for these draw processes/runs: three different inner diameters of the outer cladding of the hollow-core optical fiber, i.e., ID_{fiber}=45.0 μm, ID_{fiber}=90.0 μm, and ID_{fiber}=135.0 μm, are targeted while the outer diameter of the outer cladding of the hollow-core optical fiber OD_{fiber} is varied; substantially the same inner diameter of the outer tube of the hollow-core preform ID_{preform} of about 5.0 mm is considered while the outer diameter of the outer tube of the hollow-core preform OD_{preform} is varied; the fiber draw rate V_{f} is varied while a constant preform feed rate Vₚ of 5 mm/min is utilized; and the draw tension τ is varied so that a wide range of draw stress levels are examined; the differential core pressure P_{core} and draw stress are calculated using equation and equation [15], respectively.

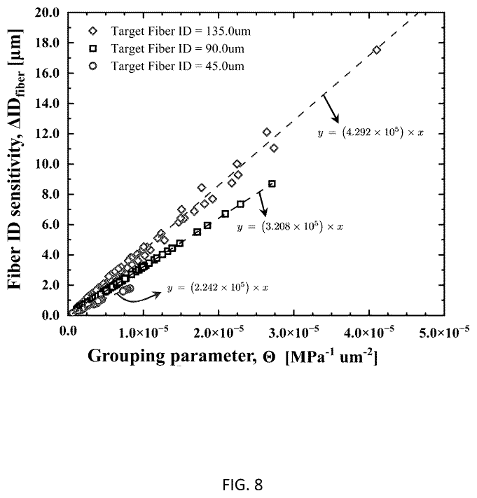

The modeling analysis of these draw processes/runs is reflected in FIG. 8, which plots the fiber dimension sensitivity ΔID_{fiber}, more specifically, variation in the inner diameter of the outer cladding of the hollow-core optical fiber in μm, as a function of a grouping parameter Θ in MPa⁻¹ um⁻², which is defined as:

$$Θ = A \times {x}^{- 1.18} \times Fiber {Thickness}^{- 2} \qquad [ 20 ]$$

where x is the draw stress as determined based on equation [15] above, and Fiber Thickness refers to the thickness of the outer cladding of the hollow-core optical fiber as defined by the difference between the outer radius R_{f}=½ OD_{fiber} and the inner radius r_{f}=½ ID_{fiber} of the outer cladding, and thus, Fiber Thickness=R_{f}−r_{f}=½ OD_{fiber}−½ ID_{fiber}, and A is the scaling factor as given in equation [18] above. Combining equations [15], [18], and [20], the following is obtained:

$$Θ = \frac{O {D}_{preform}^{2} - I {D}_{preform}^{2}}{136} \times {( \frac{4}{π} \times \frac{τ}{( O {D}_{fiber}^{2} - I {D}_{fiber}^{2} )} )}^{- 1.18} \times {( \frac{1}{2} O {D}_{fiber} - \frac{1}{2} I {D}_{fiber} )}^{- 2} \qquad [ 21 ]$$

Based on the modeling analysis shown in FIG. 8, for the same target fiber dimension, more specifically, the same target inner diameter ID_{fiber} of the outer cladding of the hollow-core optical fiber, the fiber dimension sensitivity ΔID_{fiber} may be linearly related to the grouping parameter Θ. Further, a relation between the fiber dimension sensitivity ΔID_{fiber} and the grouping parameter Θ can be derived as follows for drawing hollow-core optical fibers where the inner diameter ID_{fiber} of the outer cladding may be in the range of 45 μm to 135 μm:

$$Δ I {D}_{fiber} = M \times Θ \qquad [ 22 ]$$

where M is a proportionality constant (in MPa um³) dependent on the target inner diameter ID_{fiber} of the outer cladding of the hollow-core optical fiber drawn, and is given by the following:

$$M = 2277.7 \; 78 \times I {D}_{fiber} + ( 1.197 \times 1 {0}^{5} ) \qquad [ 23 ]$$

Table 6 below provides the values of the proportionality constant M for select target inner diameters ID_{fiber} of the outer cladding of the hollow-core optical fiber drawn. For drawing hollow-core optical fibers where the inner diameter ID_{fiber} of the outer cladding may range from 45 μm to 135 μm, the proportionality constant M may be greater than or equal to (i.e., ≥) 2.0×10⁵ and less than or equal to (i.e., ≤) 4.5×10⁵—including all sub-ranges or values therebetween. For example, in some embodiments, the proportionality constant M may be ≥2.242×10⁵ and less than or equal to (i.e., ≤) 4.292×10⁵. For example, in some embodiments, the proportionality constant M may be ≥2.0×10⁵ and ≤4.5×10⁵, ≥2.0×10⁵ and ≤4.0×10⁵, ≥2.0×10⁵ and ≤3.5×10⁵, ≥2.0×10⁵ and ≤3.0×10⁵, ≥2.0×10⁵ and ≤2.5×10⁵, ≥2.5×10⁵ and ≤4.5×10⁵, ≥2.5×10⁵ and ≤4.0×10⁵, ≥2.5×10⁵ and ≤3.5×10⁵, ≥2.5×10⁵ and ≤3.0×10⁵, ≥3.0×10⁵ and ≤4.5×10⁵, ≥3.0×10⁵ and ≤4.0×10⁵, ≥3.0×10⁵ and ≤3.5×10⁵, ≥3.5×10⁵ and ≤4.5×10⁵, ≥3.5×10⁵ and ≤4.0×10⁵, or ≥4.0×10⁵ and ≤4.5×10⁵. In some embodiments, the proportionality constant M may be greater than or equal to (i.e., ≥) 2.0, ≥2.2, ≥2.4, ≥2.6, ≥2.8, ≥3.0, ≥3.2, ≥3.4, ≥3.6, ≥3.8, ≥4.0, ≥4.2, ≥4.4, or greater. In some embodiments, the proportionality constant M may be less than or equal to (i.e., ≤) 4.5, ≤4.3, ≤4.1, ≤3.9, ≤3.7, ≤3.5, ≤3.3, ≤3.1, ≤2.9, ≤2.7, ≤2.5, ≤2.3, ≤2.1, or less.

TABLE 6

| Target Fiber ID_{fiber} [um] | Proportionality Constant, M [MPa um³] |
|---|---|
| 45.0 | 2.242 × 10⁵ |
| 90.0 | 3.208 × 10⁵ |
| 135.0 | 4.292 × 10⁵ |

Further, using the grouping parameter Q, the desired range of the fiber dimension sensitivity ΔID_{fiber} may be quantitatively tracked. For example, for drawing hollow-core optical fibers with a target outer cladding inner diameter ID_{fiber} of greater than or equal to (i.e., ≥) 45 μm and less than or equal to (i.e., ≤) 135 μm, to achieve a fiber dimension sensitivity ΔID_{fiber} of less than or equal to (i.e., ≤) 5.0 μm, the grouping parameter Θ may be less than or equal to (i.e., ≤) 2.2×10⁵, ≤1.5×10⁵, ≤1.2×10⁵, or less, and to achieve a fiber dimension sensitivity ΔID_{fiber} of less than or equal to (i.e., ≤) 2.0 μm, the grouping parameter Θ may be less than or equal to (i.e., ≤) 0.9×10⁻⁵, ≤0.7×10⁵, ≤0.5×10⁻⁵, or less. Table 7 below provides exemplary grouping parameter Θ ranges for achieving desired levels of fiber dimension sensitivity ΔID_{fiber} for select target inner diameter of the outer cladding of the hollow-core optical fiber that may be drawn using the processes described herein.

TABLE 7

| | Grouping parameter | Grouping parameter |
|---|---|---|
| Target Fiber | Θ range for achieving | Θ range for achieving |
| ID_{fiber} [um] | ΔID_{fiber} < 2 μm | 2 μm < ΔID_{fiber} < 5 μm |
| 45.0 | 0 < Θ < 0.9 × 10⁻⁵ | 0.9 × 10⁻⁵ < Θ < 2.2 × 10⁻⁵ |
| 90.0 | 0 < Θ < 0.7 × 10⁻⁵ | 0.7 × 10⁻⁵ < Θ < 1.5 × 10⁻⁵ |
| 135.0 | 0 < Θ < 0.5 × 10⁻⁵ | 0.5 × 10⁻⁵ < Θ < 1.2 × 10⁻⁵ |

### (e) Draw Tension for Maintaining Fiber Dimension Sensitivity ΔID_{fiber}

Further exemplary fiber draw processes/runs are modeled to analyze the draw tension needed for maintaining the same fiber dimension sensitivity ΔID_{fiber}. The following are implemented for these draw processes/runs: the same inner diameter ID_{fiber} of 10⁵ μm of the outer cladding of the hollow-core optical fiber and the same fiber dimension sensitivity ΔID_{fiber} of 5 μm are targeted; different outer diameters OD_{fiber} of the outer cladding of the hollow-core optical fiber, more specifically, OD_{fiber} of 125 μm, 140 μm, 160 μm, 180 μm, 200 μm, 225 μm, and 260 μm, are considered for different thicknesses of the outer cladding of the hollow-core optical fiber; the following outer diameter OD_{preform}×inner diameter ID_{preform} combinations for the outer tube of the hollow-core preform are considered for different fiber yields: 12.5 mm×4.5 mm, 17.5 mm×5.0 mm, 25.0 mm×5.0 mm, and 50.0 mm×5.0 mm; the preform feed rate is kept at Vₚ of 5 mm/min while the fiber draw rate V_{f} is varied from 30,000 mm/min to 600,000 mm/min.

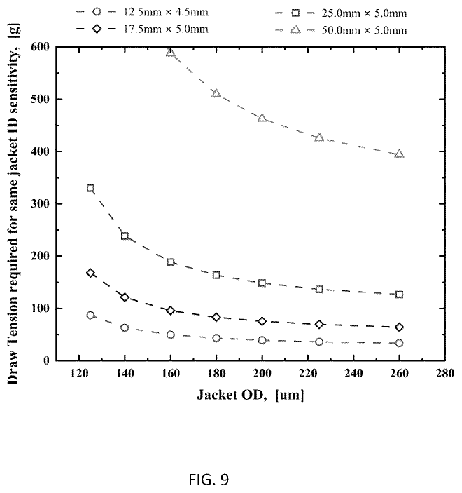

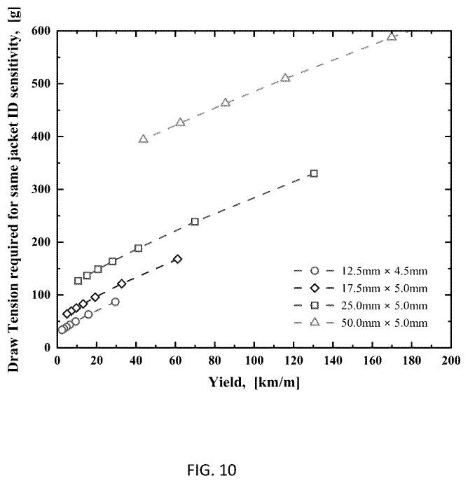

Using equations [21]-[23] above and ΔID_{fiber} of 5 μm and the various ID_{fiber}, OD_{fiber}, ID_{preform}, and OD_{preform} values as the input, the draw tension τ needed for maintaining the fiber dimension sensitivity ΔID_{fiber} of 5 μm can be calculated, and the results are plotted in FIGS. 9 and 10. Specifically, FIG. 9 plots the draw tension needed for maintaining the fiber dimension sensitivity ΔID_{fiber} of 5 μm as a function of the outer diameter OD_{fiber} of the outer cladding of the hollow-core optical fiber drawn, and FIG. 10 plots the draw tension needed for maintaining the fiber dimension sensitivity ΔID_{fiber} of 5 μm as a function of the fiber yield from different preforms.

As shown, a greater draw tension may be needed to maintain the same level of fiber dimension sensitivity ΔID_{fiber} for drawing a thinner outer cladding (or smaller outer diameter OD_{fiber} of the outer cladding) of the hollow-core optical fiber. However, there may be an inherent upper limit to the draw tension that may be applied during the drawing process before the fiber may break. Thus, when drawing larger preforms to increase fiber yield, the draw tension range that may be implemented for maintaining the same fiber dimension sensitivity ΔID_{fiber} may become narrower.

### Operating Parameters

The various methods and relations described herein may be implemented with a wide range of operating parameters for scaling up the drawing of hollow-core optical fibers from hollow-core preforms of various sizes while maintaining a tight control over target microstructure dimensions of the hollow-core optical fibers drawn.

### Draw Tension

In some embodiments, the draw tension under which the hollow-core optical fiber may be drawn from a hollow-core preform may be greater than or equal to (i.e., ≥) 50 g and less than or equal to (i.e., ≤) 600 g-including all sub-ranges or values therebetween. For example, in some embodiments, the draw tension may be ≥50 g and ≤600 g, ≥50 g and ≤550 g, ≥50 g and ≤500 g, ≥50 g and ≤450 g, ≥50 g and ≤400 g, ≥50 g and ≤350 g, ≥50 g and ≤300 g, ≥50 g and ≤250 g, ≥50 g and ≤200 g, ≥50 g and ≤150 g, ≥50 g and ≤100 g, ≥100 g and ≤600 g, ≥100 g and ≤550 g, ≥100 g and ≤500 g, ≥100 g and ≤450 g, ≥100 g and ≤400 g, ≥100 g and ≤350 g, ≥100 g and ≤300 g, ≥100 g and ≤250 g, ≥100 g and ≤200 g, ≥100 g and ≤150 g, ≥150 g and ≤600 g, ≥150 g and ≤550 g, ≥150 g and ≤500 g, ≥150 g and ≤450 g, ≥150 g and ≤400 g, ≥150 g and ≤350 g, ≥150 g and ≤300 g, ≥150 g and ≤250 g, ≥150 g and ≤200 g, ≥200 g and ≤600 g, ≥200 g and ≤550 g, ≥200 g and ≤500 g, ≥200 g and ≤450 g, ≥200 g and ≤400 g, ≥200 g and ≤350 g, ≥200 g and ≤300 g, ≥200 g and ≤250 g, ≥250 g and ≤600 g, ≥250 g and ≤550 g, ≥250 g and ≤500 g, ≥250 g and ≤450 g, ≥250 g and ≤400 g, ≥250 g and ≤350 g, ≥250 g and ≤300 g, ≥300 g and ≤600 g, ≥300 g and ≤550 g, ≥300 g and ≤500 g, ≥300 g and ≤450 g, ≥300 g and ≤400 g, ≥300 g and ≤350 g, ≥350 g and ≤600 g, ≥350 g and ≤550 g, ≥350 g and ≤500 g, ≥350 g and ≤450 g, ≥350 g and ≤400 g, ≥400 g and ≤600 g, ≥400 g and ≤550 g, ≥400 g and ≤500 g, ≥400 g and ≤450 g, ≥450 g and ≤600 g, ≥450 g and ≤550 g, ≥450 g and ≤500 g, ≥500 g and ≤600 g, ≥500 g and ≤550 g, ≥550 g and ≤600 g, or ≥550 g and ≤600 g.

In some embodiments, the draw tension under which the hollow-core optical fiber may be drawn from a hollow-core preform may be greater than or equal to (i.e., ≥) 50 g, ≥70 g, ≥90 g, ≥110 g, ≥130 g, ≥150 g, ≥170 g, ≥190 g, ≥210 g, ≥230 g, ≥250 g, ≥270 g, ≥290 g, ≥310 g, ≥330 g, ≥350 g, ≥370 g, ≥390 g, ≥410 g, ≥430 g, ≥450 g, ≥470 g, ≥490 g, ≥510 g, ≥530 g, ≥550 g, ≥570 g, ≥590 g, or greater. In some embodiments, the draw tension under which the hollow-core optical fiber may be drawn from the hollow-core preform may be less than or equal to (i.e., ≤) 600 g, ≤580 g, ≤560 g, ≤540 g, ≤520 g, ≤500 g, ≤480 g, ≤460 g, ≤440 g, ≤420 g, 400 g, ≤380 g, ≤360 g, ≤340 g, ≤320 g, ≤300 g, ≤280 g, ≤260 g, ≤240 g, ≤220 g, ≤200 g, ≤180 g, ≤160 g, ≤140 g, <120 g, ≤100 g, ≤80 g, ≤60 g, or less.

### Draw Speed

In some embodiments, the hollow-core optical fiber may be drawn at a draw speed of greater than or equal to (i.e., ≥) 1 m/s and less than or equal to (i.e., ≤) 20 m/s—including all sub-ranges or values therebetween. For example, in some embodiments, the draw speed may be ≥1 m/s and ≤20 m/s, ≥1 m/s and ≤15 m/s, ≥1 m/s and ≤10 m/s, ≥1 m/s and ≤5 m/s, ≥5 m/s and ≤20 m/s, ≥5 m/s and ≤15 m/s, ≥5 m/s and ≤10 m/s, ≥10 m/s and ≤20 m/s, ≥10 m/s and ≤15 m/s, or ≥15 m/s and ≤20 m/s. In some embodiments, the hollow-core optical fiber may be drawn at a draw speed of greater than or equal to (i.e., ≥) 1 m/s, ≥3 m/s, ≥5 m/s, ≥7 m/s, ≥9 m/s, ≥11 m/s, ≥13 m/s, ≥15 m/s, ≥17 m/s, ≥19 m/s, or greater.

### Preform Feed Rate

In some embodiments, the hollow-core preform may be fed into the draw furnace at a preform feed rate Vₚ that may be greater than or equal to (i.e., ≥) 5 mm/min and less than or equal to (i.e., ≤) 100 mm/min-including all sub-ranges or values therebetween. For example, in some embodiments, the hollow-core preform may be fed into the draw furnace at a preform feed rate Vₚ that may be ≥5 mm/min and ≤100 mm/min, ≥5 mm/min and ≤75 mm/min, ≥5 mm/min and ≤50 mm/min, ≥5 mm/min and ≤25 mm/min, ≥25 mm/min and ≤100 mm/min, ≥25 mm/min and ≤75 mm/min, ≥25 mm/min and ≤50 mm/min, ≥50 mm/min and ≤100 mm/min, ≥50 mm/min and ≤75 mm/min, or ≥75 mm/min and ≤100 mm/min. In some embodiments, the hollow-core preform may be fed into the draw furnace at a preform feed rate Vₚ that may be ≥5 mm/min, ≥10 mm/min, ≥15 mm/min, ≥20 mm/min, ≥25 mm/min, ≥30 mm/min, ≥35 mm/min, ≥40 mm/min, ≥45 mm/min, ≥50 mm/min, ≥55 mm/min, ≥60 mm/min, ≥65 mm/min, ≥70 mm/min, ≥75 mm/min, ≥80 mm/min, ≥85 mm/min, ≥90 mm/min, ≥95 mm/min, or greater. In some embodiments, the hollow-core preform may be fed into the draw furnace at a preform feed rate Vₚ that may be less than or equal to 100 mm/min, ≤95 mm/min, ≤90 mm/min, ≤85 mm/min, ≤80 mm/min, ≤75 mm/min, ≤70 mm/min, ≤65 mm/min, <60 mm/min, ≤55 mm/min, ≤50 mm/min, ≤45 mm/min, ≤40 mm/min, ≤35 mm/min, ≤30 mm/min, ≤25 mm/min, ≤20 mm/min, ≤15 mm/min, ≤10 mm/min, or less.

### Differential Core Pressure P_{core}

In some embodiments, the differential core pressure P_{core} may be greater than or equal to (i.e., ≥) 0.01 psig and less than or equal to (i.e., ≤) 2 psig-including all sub-ranges or values therebetween. For example, in some embodiments, the differential core pressure P_{core} may be may be ≥0.01 psig and ≤2 psig, ≥0.01 psig and ≤1.5, ≥0.01 psig and ≤1, ≥0.01 psig and ≤0.5, ≥0.01 psig and ≤0.1 psig, ≥0.1 psig and ≤2 psig, ≥0.1 psig and ≤1.5, ≥0.1 psig and ≤1, ≥0.1 psig and ≤0.5, ≥0.5 psig and ≤2 psig, ≥0.5 psig and ≤1.5, ≥0.5 psig and ≤1, ≥1 psig and ≤2 psig, ≥1 psig and ≤1.5, or ≥1.5 psig and ≤2 psig.

In some embodiments, the differential core pressure P_{core} may be greater than or equal to (i.e., ≥) 0.01 psig, ≥0.05 psig, ≥0.1 psig, ≥0.2 psig, ≥0.3 psig, ≥0.4 psig, ≥0.5 psig, ≥0.6 psig, ≥0.7 psig, ≥0.8 psig, ≥0.9 psig, ≥1 psig, ≥1.1 psig, ≥1.2 psig, ≥1.3 psig, ≥1.4 psig, ≥1.5 psig, ≥1.6 psig, ≥1.7 psig, ≥1.8 psig, ≥1.9 psig, or greater. In some embodiments, the differential core pressure P_{core} may be less than or equal to (i.e., ≤) 2 psig, ≤1.9 psig, ≤1.8 psig, ≤1.7 psig, ≤1.6 psig, ≤1.5 psig, ≤1.4 psig, <1.3 psig, <1.2 psig, ≤1.1 psig, ≤1 psig, ≤0.9 psig, ≤0.8 psig, ≤0.7 psig, ≤0.6 psig, ≤0.5 psig, ≤0.4 psig, ≤0.3 psig, ≤0.2 psig, ≤0.1 psig, ≤0.05 psig, or less.

### Preform Outer Tube Dimensions

In some embodiments, the inner diameter of the outer tube of the hollow-core preform (ID_{Preform}=2×rₚ) may be greater than or equal to (i.e., ≥) 4 mm and less than or equal to (i.e., ≤) 20 mm-including all sub-ranges or values therebetween. For example, in some embodiments, the inner diameter of the outer tube of the hollow-core preform (ID_{Preform}=2×rₚ) may be ≥4 mm and ≤20 mm, ≥4 mm and ≤16 mm, ≥4 mm and ≤12 mm, ≥4 mm and 8 mm, ≥8 mm and ≤20 mm, ≥8 mm and ≤16 mm, ≥8 mm and ≤12 mm, ≥12 mm and ≤20 mm, ≥12 mm and ≤16 mm, or ≥16 mm and ≤20 mm. In some embodiments, the inner diameter of the outer tube of the hollow-core preform (ID_{Preform}=2×rₚ) may be greater than or equal to (i.e., ≥) 4 mm, ≥5 mm, ≥6 mm, ≥7 mm, ≥8 mm, ≥9 mm, ≥10 mm, ≥11 mm, ≥12 mm, ≥13 mm, ≥14 mm, ≥15 mm, ≥16 mm, ≥17 mm, ≥18 mm, ≥19 mm, or greater. In some embodiments, the inner diameter of the outer tube of the hollow-core preform (ID_{Preform}=2×rₚ) may be less than or equal to (i.e., ≤) 20 mm, ≤19 mm, ≤18 mm, ≤17 mm, ≤16 mm, ≤15 mm, ≤14 mm, ≤13 mm, ≤12 mm, ≤11 mm, ≤10 mm, ≤9 mm, <8 mm, <7 mm, ≤6 mm, ≤5 mm, or less.

In some embodiments, the outer diameter of the outer tube of the hollow-core preform (OD_{preform}=2×Rₚ) may be greater than or equal to (i.e., ≥) 15 mm and less than or equal to (i.e., ≤) to 100 mm-including all sub-ranges or values therebetween. For example, in some embodiments, the outer diameter of the outer tube of the hollow-core preform (OD_{preform}=2×Rₚ) may be ≥15 mm and <100 mm, ≥15 mm and ≤75 mm, ≥15 mm and ≤50 mm, ≥15 mm and ≤25 mm, ≥25 mm and ≤100 mm, ≥25 mm and ≤75 mm, ≥25 mm and ≤50 mm, ≥50 mm and ≤100 mm, ≥50 mm and ≤75 mm, or ≥75 mm and ≤100 mm. In some embodiments, the outer diameter of the outer tube of the hollow-core preform (OD_{preform}=2×Rₚ) may be greater than or equal to (i.e., ≥) 15 mm, ≥20 mm, ≥25 mm, ≥30 mm, ≥35 mm, ≥40 mm, ≥45 mm, ≥50 mm, ≥55 mm, ≥60 mm, ≥65 mm, ≥70 mm, ≥75 mm, ≥80 mm, ≥85 mm, ≥90 mm, ≥95 mm, or greater. In some embodiments, the outer diameter of the outer tube of the hollow-core preform (OD_{preform}=2×Rₚ) may be less than or equal to (i.e., ≤) 100 mm, ≤95 mm, ≤90 mm, ≤85 mm, ≤80 mm, ≤75 mm, ≤70 mm, ≤65 mm, ≤60 mm, ≤55 mm, ≤50 mm, ≤45 mm, ≤40 mm, ≤35 mm, ≤30 mm, ≤25 mm, ≤20 mm, or less.

### Fiber Outer Cladding Dimensions

In some embodiments, the inner diameter of the outer cladding of the hollow-core optical fiber (ID_{fiber}=2×r_{f}) may be greater than or equal to (i.e., ≥) 45 μm and less than or equal to (i.e., ≤) 135 μm-including all sub-ranges or values therebetween. For example, in some embodiments, the inner diameter of the outer cladding of the hollow-core optical fiber (ID_{fiber}=2×r_{f}) may be ≥45 μm and ≤135 μm, ≥45 μm and ≤115 μm, ≥45 μm and ≤95 μm, ≥45 μm and ≤75 μm, ≥45 μm and ≤55 μm, ≥55 μm and ≤135 μm, ≥55 μm and ≤115 μm, ≥55 μm and ≤95 μm, ≥55 μm and ≤75 μm, ≥75 μm and ≤135 μm, ≥75 μm and ≤115 μm, ≥75 μm and ≤95 μm, ≥95 μm and ≤135 μm, ≥95 μm and ≤115 μm, or ≥115 μm and ≤135 μm. In some embodiments, the inner diameter of the outer cladding of the hollow-core optical fiber (ID_{fiber}=2×r_{f}) may be greater than or equal to (i.e., ≥) 45 μm, ≥50 mm, ≥55 mm, ≥60 mm, ≥65 mm, ≥70 mm, ≥75 mm, ≥80 mm, ≥85 mm, ≥90 mm, ≥95 mm, ≥100 mm, ≥105 mm, ≥110 mm, ≥115 mm, ≥120 mm, ≥125 mm, ≥130 μm, or greater. In some embodiments, the inner diameter of the outer cladding of the hollow-core optical fiber (ID_{fiber}=2×r_{f}) may be less than or equal to (i.e., ≤) 135 μm, ≤130 μm, ≤125 μm, ≤120 μm, ≤115 μm, ≤110 μm, ≤105 μm, ≤100 μm, ≤95 μm, ≤90 μm, ≤85 μm, ≤80 μm, ≤75 μm, ≤70 μm, ≤65 μm, ≤60 μm, ≤55 μm, ≤50 μm, or less.

In some embodiments, the outer diameter of the outer cladding of the hollow-core optical fiber (2×R_{ocf}) may be greater than or equal to (i.e., ≥) 150 μm and less than or equal to (i.e., ≤) 300 μm-including all sub-ranges or values therebetween. For example, in some embodiments, the outer diameter of the outer cladding of the hollow-core optical fiber (2×R_{ocf}) may be ≥150 μm and ≤300 μm, ≥150 μm and ≤250 μm, ≥150 μm and ≤200 μm, ≥200 μm and ≤300 μm, ≥200 μm and ≤250 μm, or ≥250 μm and ≤300 μm. In some embodiments, the outer diameter of the outer cladding of the hollow-core optical fiber (2×R_{ocf}) may be greater than or equal to (i.e., ≥) 150 μm, ≥160 μm, ≥170 μm, ≥180 μm, ≥190 μm, ≥200 μm, ≥210 μm, ≥220 μm, ≥230 μm, ≥240 μm, ≥250 μm, ≥260 μm, ≥270 μm, ≥280 μm, ≥290 μm, or greater. In some embodiments, the outer diameter of the outer cladding of the hollow-core optical fiber (2×R_{ocf}) may be less than or equal to (i.e., ≤) 300 μm, ≤290 μm, ≤280 μm, ≤270 μm, ≤260 μm, ≤250 μm, ≤240 μm, ≤230 μm, ≤220 μm, ≤210 μm, ≤200 μm, ≤190 μm, ≤180 μm, ≤170 μm, ≤160 μm, or less.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A method of producing a hollow-core optical fiber from a hollow-core preform, the method comprising:
feeding a hollow-core preform into a draw furnace at a preform feed rate Vₚ in mm/min;
heating the hollow-core preform comprising an outer tube, wherein the outer tube comprises an inner surface defining an interior cavity and an inner radius rₚ in mm of the outer tube of the hollow-core preform and an outer surface defining an outer radius Rₚ in mm of the outer tube of the hollow-core preform; and
drawing a hollow-core optical fiber from the hollow-core preform at a fiber draw rate V_{f} in mm/min and a draw tension τ in grams, thereby elongating the outer tube of the hollow-core preform to an outer cladding of the hollow-core optical fiber, wherein the outer cladding comprises an inner surface defining an inner radius r_{f} in μm of the outer cladding of the hollow-core fiber and an outer surface defining an outer radius R_{f} in μm of the outer cladding of the hollow-core optical fiber;
wherein:
the interior cavity of the outer tube of the hollow-core preform is under a differential core pressure P_{core} in psig that satisfies the following relation:
$$0 \text{.8} \times P * < {P}_{core} < 1 \text{.2} \times P * ,$$
$$where :$$
$$P *= 1.877 \times 1 {0}^{- 5} \times {τ}^{1.46} ,$$
the inner radius rₚ of the outer tube of the hollow-core preform and the outer radius Rₚ of the outer tube of the hollow-core preform satisfy the following relations:
$$0.9 \times {r}_{p}^{*} < {r}_{p} < 1.1 \times {r}_{p}^{*} ,$$
$$0.95 \times {R}_{p}^{*} < {R}_{p} < 1.05 \times {R}_{p}^{*} ,$$
$$where :$$
$${r}_{p}^{*} = \frac{{r}_{f}}{{( {V}_{f} / {V}_{p} )}^{- ( T + 3 π {R}_{*} σ - 3 π {P}_{core} {R}_{*}^{2} ) / 2 T}} ,$$
$${R}_{p}^{*} = \frac{{R}_{f}}{{( {V}_{f} / {V}_{p} )}^{- ( T + 3 π {r}_{*} σ - 3 π {P}_{core} {r}_{*}^{2} ) / 2 T}} ,$$
where:
T is the draw tension in dynes, and T=981×τ,
σ is a surface energy of a material forming the outer tube;
$${r}_{*} = 5 \sqrt{{r}_{p}^{*} {r}_{f}} ; and$$
$${R}_{*} = 5 \sqrt{{R}_{p}^{*} {R}_{f}} .$$

2. The method of claim 1, wherein the draw tension τ in gram under which the hollow-core optical fiber is drawn is greater than or equal to 50 g and less than or equal to 600 g.

3. The method of claim 1, wherein the differential core pressure P_{core} in the interior cavity of the outer tube of the hollow-core preform is greater than or equal to 0.01 psig and less than or equal to 2 psig.

4. The method of claim 1, wherein a fiber draw speed (V_{f} divided by 60,000) is greater than or equal to 1 m/s and less than or equal to 20 m/s.

5. The method of claim 1, wherein the preform feed rate Vₚ is greater than or equal to 5 mm/min and less than or equal to 100 mm/min.

6. The method of claim 1, wherein the outer diameter of the outer tube of the hollow-core preform (OD_{preform}=2×Rₚ) is greater than or equal to 15 mm and less than or equal to 100 mm.

7. The method of claim 1, wherein the inner diameter of the outer tube of the hollow-core preform (ID_{Preform}=2×rₚ) is greater than or equal to 4 mm and less than or equal to 20 mm.

8. The method of claim 1, wherein the outer diameter of the outer cladding of the hollow-core optical fiber (OD_{fiber}=2×R_{f}) is greater than or equal to 150 μm and less than or equal to 300 μm.

9. The method of claim 1, wherein the inner diameter of the outer cladding of the hollow-core optical fiber (ID_{fiber}=2×r_{f}) is greater than or equal to 45 μm and less than or equal to 135 μm.

10. The method of claim 1, wherein the draw furnace comprises a hot zone having an axial length greater than or equal to 3 cm and less than or equal to 50 cm.

11. The method of claim 1, wherein the hollow-core preform further comprises an inner tube in contact with the inner surface of the outer tube of the hollow-core preform, wherein the drawing further elongates the inner tube of the hollow-core preform to a capillary of the hollow-core optical fiber in contact with the inner surface of the outer cladding of the hollow-core optical fiber.

12. The method of claim 1, wherein the hollow-core preform further comprises a nested tube in contact with an inner surface of the inner tube of the hollow-core preform, wherein the drawing further elongates the nested tube of the hollow-core preform to a nested capillary of the hollow-core optical fiber in contact with an inner surface of the inner tube of the hollow-core optical fiber.

13. A method of producing a hollow-core optical fiber from a hollow-core preform, the method comprising:
feeding a hollow-core preform into a draw furnace at a preform feed rate Vₚ (in mm/min);
heating the hollow-core preform comprising an outer tube, wherein the outer tube comprises an inner surface defining an interior cavity and an inner diameter ID_{preform} (in mm) of the outer tube of the hollow-core preform and an outer surface defining an outer diameter OD_{preform} (in mm) of the outer tube of the hollow-core preform; and
drawing a hollow-core optical fiber from the hollow-core preform at a fiber draw rate V_{f} (in mm/min) and a draw tension τ, thereby elongating the outer tube of the hollow-core preform to an outer cladding of the hollow-core optical fiber, wherein the outer cladding comprises an inner surface defining an inner diameter ID_{fiber} (in μm) of the outer cladding of the hollow-core fiber and an outer surface defining an outer diameter OD_{fiber} (in μm) of the outer cladding of the hollow-core optical fiber;
wherein a fiber dimension sensitivity ΔID_{fiber} (in μm), as defined as a variation in the inner diameter ID_{fiber} of the outer cladding of the hollow-core optical fiber when a differential core pressure P_{core} undergoes a fluctuation of 0.01 psig, satisfies the following:
$$Δ I {D}_{fiber} = M \times Θ$$
where:
M is a proportionality constant and M=2277.778×ID_{fiber}+(1.197×10⁵),
Θ is a grouping parameter and
$$Θ = A \times {x}^{- 1.18} \times {T}_{fiber}^{- 2} ,$$
where:
A is a scaling factor and
$$A = \frac{O {D}_{preform}^{2} - I {D}_{preform}^{2}}{136} ,$$
x is the operating draw stress (in MPa) and
$$x = \frac{4}{π} \times \frac{τ}{( O {D}_{fiber}^{2} - I {D}_{fiber}^{2} )} ,$$
and
T_{fiber} (in μm) is the thickness of the outer cladding of the hollow-core optical fiber and
$${T}_{fiber} = \frac{1}{2} O {D}_{fiber} - \frac{1}{2} I {D}_{fiber} .$$

14. The method of claim 13, wherein:
the interior cavity of the outer tube of the hollow-core preform is under a differential core pressure P_{core} in psig that satisfies the following relation:
$$0.8 \times P * < {P}_{core} < 1 \text{.2} \times P * ,$$
$$where :$$
$$P *= 1.877 \times 1 {0}^{- 5} \times {τ}^{1.46} ,$$
the inner radius rₚ of the outer tube of the hollow-core preform and the outer radius Rₚ of the outer tube of the hollow-core preform satisfy the following relations:
$$0.9 \times {r}_{p}^{*} < {r}_{p} < 1.1 \times {r}_{p}^{*} ,$$
$$0.95 \times {R}_{p}^{*} < {R}_{p} < 1.05 \times {R}_{p}^{*} ,$$
$$where :$$
$${r}_{p}^{*} = \frac{{r}_{f}}{{( {V}_{f} / {V}_{p} )}^{- ( T + 3 π {R}_{*} σ - 3 π {P}_{core} {R}_{*}^{2} ) / 2 T}} ,$$
$${R}_{p}^{*} = \frac{{R}_{f}}{{( {V}_{f} / {V}_{p} )}^{- ( T + 3 π {r}_{*} σ - 3 π {P}_{core} {r}_{*}^{2} ) / 2 T}} ,$$
where:
T is the draw tension in dynes, and T=981×τ,
σ is a surface energy of a material forming the outer tube of the hollow-core preform,
$${r}_{*} = 5 \sqrt{{r}_{p}^{*} {r}_{f}} ; and$$
$${R}_{*} = 5 \sqrt{{R}_{p}^{*} {R}_{f}} .$$

15. The method of claim 13, wherein the inner diameter ID_{fiber} of the outer cladding of the hollow-core optical fiber is greater than or equal to 45 μm and less than or equal to 135 μm.

16. The method of claim 13, wherein the fiber dimension sensitivity ΔID_{fiber} satisfies at least one of:
$$Δ I {D}_{fiber} < 5. μm ; or$$
$$Δ I {D}_{fiber} < 2. μm .$$

17. The method of claim 13, wherein the grouping parameter Θ satisfies at least one of:
$$0 < Θ < 2.2 \times 1 {0}^{- 5} ;$$
$$0 < Θ < 1.5 \times 1 {0}^{- 5} ;$$
$$0 < Θ < 1.2 \times 1 {0}^{- 5} ;$$
$$0 < Θ < 0.9 \times 1 {0}^{- 5} ;$$
$$0 < Θ < 0.7 \times 1 {0}^{- 5} ; or$$
$$0 < Θ < 0.5 \times 1 {0}^{- 5} .$$

18. The method of claim 13, wherein the proportionality constant M satisfies at least one of:
$$M \geq 2.0 \times 1 {0}^{5} ;$$
$$M \leq 4. 5 \times 1 {0}^{5} ; or$$
$$2.242 \times 1 {0}^{5} \leq M \leq 4.292 \times 1 {0}^{5} .$$

19. The method of claim 13, wherein the differential core pressure P_{core} is greater than or equal to 0.01 psig and less than or equal to 2 psig.

20. The method of claim 13, wherein the draw tension τ is greater than or equal to 50 g and less than or equal to 600 g.
